(19) United States
(12) Patent Application Publication
(10) Pub. No.: US 2024/0316925 A1
(43) Pub. Date: Sep. 26, 2024

(54) ACTUATOR UNIT, LIQUID DISCHARGE HEAD, AND LIQUID DISCHARGE APPARATUS

(71) Applicant: Yutaro MATSUBARA, Kanagawa (JP)

(72) Inventor: Yutaro MATSUBARA, Kanagawa (JP)

(21) Appl. No.: 18/603,234

(22) Filed: Mar. 13, 2024

(30) Foreign Application Priority Data
Mar. 22, 2023 (JP) 2023-045078

(51) Int. Cl. B41J 2/14; B41J 3/407

(52) U.S. Cl. CPC B41J 2/14201; B41J 2002/14491; B41J 3/4073; B41J 2202/05; B41J 2202/22

(57) ABSTRACT

An actuator includes a piezoelectric element, a valve body, a support, a movement mechanism, and a restrictor. The piezoelectric element expands and contracts in an expansion-contraction direction. The valve body is movable in the expansion-contraction direction. The support is fitted around the piezoelectric element to expand and contract in the expansion-contraction direction with an expansion and a contraction of the piezoelectric element. The movement mechanism is coupled to the valve body and coupled to the piezoelectric element via the support. The movement mechanism moves the valve body in accordance with the expansion and the contraction of the piezoelectric element. The movement mechanism includes a fixing portion fixing a relative position of the movement mechanism to the support. The restrictor is fixed to each of the support and the fixing portion to regulate a relative position of the fixing portion to the support.

### CROSS-REFERENCE TO RELATED APPLICATION

This patent application is based on and claims priority pursuant to 35 U.S.C. § 119(a) to Japanese Patent Application No. 2023-045078, filed on Mar. 22, 2023, in the Japan Patent Office, the entire disclosure of which is hereby incorporated by reference herein.

### BACKGROUND

### Technical Field

Embodiments of the present disclosure relate to an actuator unit, a liquid discharge head, and a liquid discharge apparatus.

### Related Art

In the related art, a liquid discharge head discharges droplets of liquid (e.g., ink) from a nozzle. The liquid discharge head includes a nozzle opening-closing valve (i.e., a valve or a needle valve), a nozzle opening-closing driver (i.e., a piezoelectric element or an actuator), and a nozzle opening-closing controller. The needle valve is provided for the nozzle (nozzle hole). The nozzle opening-closing driver moves the needle valve toward and away from the nozzle. The nozzle opening-closing controller controls the nozzle opening-closing driver to open and close the nozzle to discharge the droplets of the liquid from the nozzle. Such a liquid discharge head supplies liquid to be discharged to the nozzle under pressure. In this condition, the liquid discharge head causes the nozzle opening-closing valve to contact or separate from the nozzle. By so doing, the liquid that is supplied under pressure is discharged from the nozzle as liquid droplets only while the nozzle opening-closing valve is separated from the nozzle. The liquid is discharged in accordance with the pressure applied to the liquid and the gap distance between the nozzle and the nozzle opening-closing valve that separates from the nozzle, i.e., the fluid resistance in supply and the duration of opening-closing of the nozzle opening-closing valve.

### SUMMARY

Embodiments of the present disclosure describe an improved actuator that includes a piezoelectric element, a valve body, a support, a movement mechanism, and a restrictor. The piezoelectric element expands and contracts in an expansion-contraction direction. The valve body is movable in the expansion-contraction direction. The support is fitted around the piezoelectric element to expand and contract in the expansion-contraction direction with an expansion and a contraction of the piezoelectric element. The movement mechanism is coupled to the valve body and coupled to the piezoelectric element via the support. The movement mechanism moves the valve body in accordance with the expansion and the contraction of the piezoelectric element. The movement mechanism includes a fixing portion fixing a relative position of the movement mechanism to the support. The restrictor is fixed to each of the support and the fixing portion to regulate a relative position of the fixing portion to the support.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating a discharge head according to an embodiment of the present disclosure;

FIG. 2 is a diagram illustrating the configuration of the discharge head of FIG. 1;

FIGS. 3A and 3B are diagrams each illustrating the configuration of a liquid discharge module according to a comparative example;

FIGS. 4A to 4C are diagrams each illustrating a timing chart of a voltage applied to a piezoelectric element;

FIGS. 5A and 5B are diagrams each illustrating an actuator unit according to an embodiment of the present disclosure;

FIG. 6 is a diagram illustrating the external appearance of a restrictor according to an embodiment of the present disclosure;

FIGS. 7A and 7B are diagrams each illustrating an actuator unit from which a restrictor is removed according to an embodiment of the present disclosure;

FIGS. 8A and 8B are diagrams each illustrating a configuration of a liquid discharge module according to an embodiment of the present disclosure;

FIGS. 9A and 9B are diagrams each illustrating an operation of an actuator unit according to an embodiment of the present disclosure;

FIGS. 10A and 10B are diagrams each illustrating an operation of a liquid discharge module according to an embodiment of the present disclosure;

FIGS. 11A and 11B are diagrams each illustrating a movement mechanism according to an embodiment of the present disclosure;

FIGS. 12A to 12C are diagrams each illustrating the influence of displacement of a position of a fulcrum on the movement amount of a needle valve according to an embodiment of the present disclosure;

FIGS. 13A and 13B are diagrams each illustrating the influence of a coefficient of thermal expansion of a restrictor according to an embodiment of the present disclosure on the movement amount of a needle valve.

FIGS. 14A and 14B are schematic diagrams each illustrating the overall configuration of a liquid discharge apparatus according to an embodiment of the present disclosure;

FIG. 15 is a schematic diagram illustrating the overall configuration of another liquid discharge apparatus according to an embodiment of the present disclosure;

FIG. 16 is a perspective view of the liquid discharge apparatus of FIG. 15, arranged above an automobile;

FIG. 17 is a perspective view of the liquid discharge apparatus of FIG. 15, arranged lateral to an automobile;

FIGS. 18A to 18C are diagrams each illustrating a case where liquid is discharged onto a spherical surface by the liquid discharge apparatus;

FIG. 19 is a schematic diagram of an electrode manufacturing apparatus for performing a method of manufacturing an electrode according to an embodiment of the present disclosure; and

FIG. 20 is a schematic diagram of another electrode manufacturing apparatus for performing a method of manufacturing an electrode composite layer according to an embodiment of the present disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the drawings. In the drawings for illustrating embodiments of the present disclosure, like elements or like components in function or shape are given like reference signs as far as distinguishable, and overlapping descriptions may be omitted. In the present embodiment, a liquid discharge head may be referred to as a discharge head.

A drive controller according to an embodiment of the present disclosure is described below. The drive controller controls the driving of an opening-closing valve of a liquid discharge head. In the present embodiment, the liquid discharge head discharges ink as a liquid. In the present embodiment, the liquid discharge head may be referred to as a discharge head or a head.

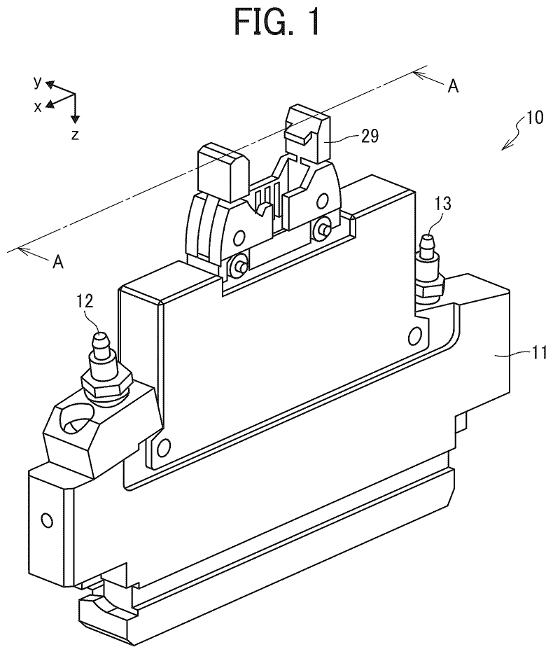

FIG. 1 is an overall perspective view of the liquid discharge head according to the present embodiment. In FIG. 1, the width direction of the liquid discharge head (direction in which nozzles are arrayed) is defined as an x direction. The depth direction of the liquid discharge head is defined as a y direction. The height direction of the liquid discharge head (opening-closing direction of a needle valve, movement direction of the needle valve, movement direction of the needle valve for contact-separation, contact-separation direction of the needle valve, or drive direction of the needle valve) is defined as a z direction. The coordinate definitions apply to the other drawings in the following description unless otherwise specified.

A liquid discharge head 10 according to the present embodiment includes a housing 11. The housing 11 is made of metal or resin. The housing 11 includes a connector 29 for communication of electrical signals at an upper portion thereof. A supply port 12 and a collection port 13 are disposed on the left and right sides of the housing 11. Ink 150 as a liquid is supplied into the liquid discharge head 10 through the supply port 12 and drained from the liquid discharge head 10 through the collection port 13.

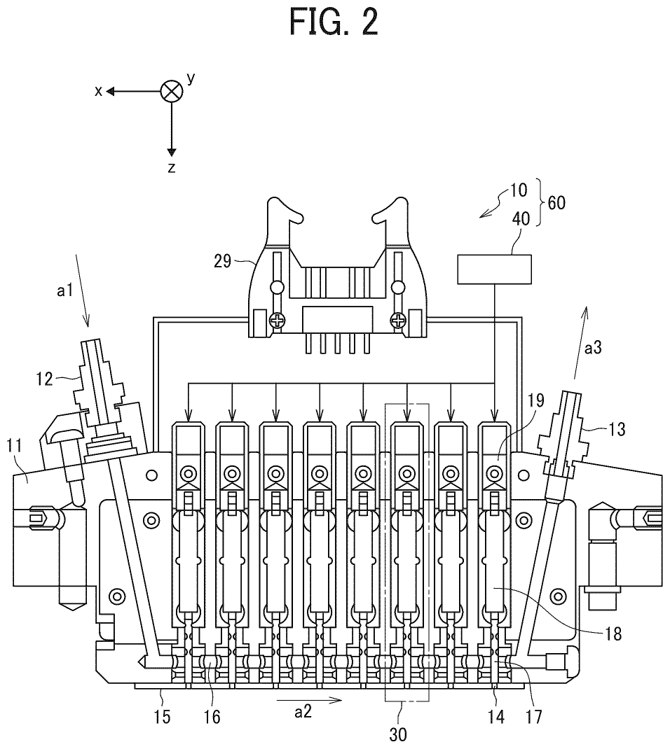

FIG. 2 illustrates a head unit and is also a cross-sectional view of the liquid discharge head 10 taken along line A-A of FIG. 1. A head unit 60 includes the liquid discharge head 10 and a drive controller 40.

The liquid discharge head 10 includes a nozzle plate 15. The nozzle plate 15 is joined to the housing 11. The nozzle plate 15 has nozzles 14 (may be referred to as nozzle holes) from which ink is discharged. The housing 11 includes a channel 16 (also referred to as a liquid chamber).

The channel 16 is a flow path through which ink 150 is fed from the supply port 12 to the collection port 13 over the nozzle plate 15. The ink 150 is fed in the channel 16 in a direction indicated by arrows a1 to a3 in FIG. 2.

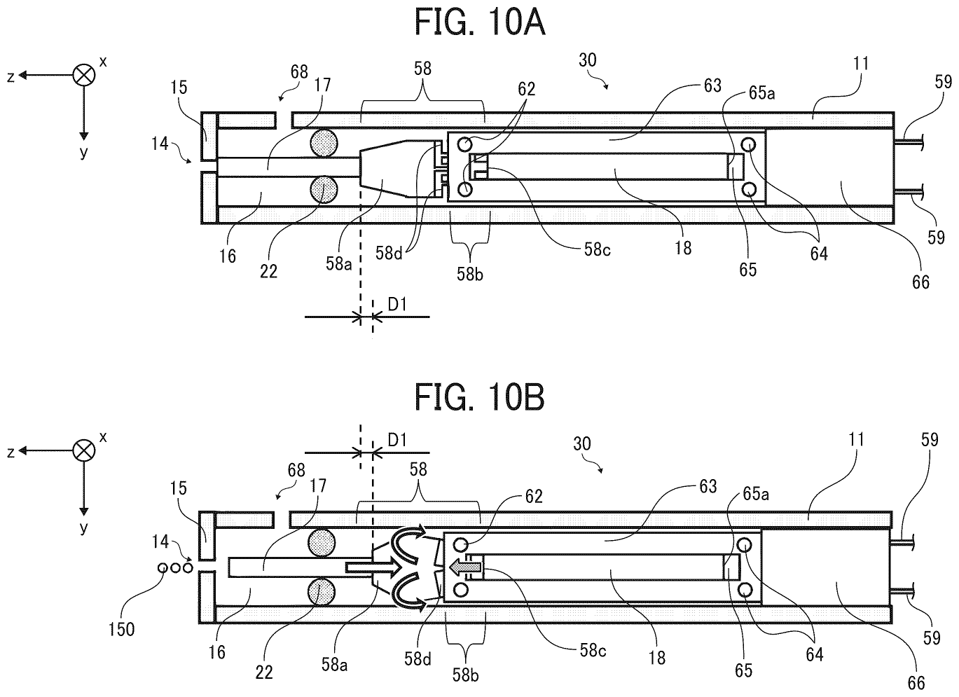

Liquid discharge modules 30 are disposed between the supply port 12 and the collection port 13. Each of the liquid discharge modules 30 discharges the ink 150 (see FIG. 10B) in the channel 16 from the nozzle 14. Each of the liquid discharge modules 30 faces the corresponding nozzle 14 of the nozzle plate 15. In the present embodiment, the eight liquid discharge modules 30 correspond to the eight nozzles 14 arranged in a row, respectively. The number and arrangement of the nozzles 14 and the liquid discharge modules 30 are not limited to eight as described above. For example, the number of nozzles 14 and the number of liquid discharge modules 30 may be one instead of plural.

The numbers of nozzles 14 and liquid discharge modules 30 may be more than eight or less than eight. The nozzles 14 and the liquid discharge modules 30 may be arranged in multiple rows instead of one row.

With the above-described configuration, the supply port 12 takes in pressurized ink from the outside of the liquid discharge head 10, feeds the ink 150 in the direction indicated by arrow a1, and supplies the ink to the channel 16. The channel 16 feeds the ink 150 from the supply port 12 in the direction indicated by arrow a2. The collection port 13 drains the ink 150 that is not discharged from the nozzles 14 in the direction indicated by arrow a3.

The nozzles 14 are arranged along the channel 16.

The liquid discharge module 30 includes a needle valve 17 and a piezoelectric element 18. The needle valve 17 opens and closes the nozzle 14, and the piezoelectric element 18 drives (moves) the needle valve 17.

The housing 11 includes a piezoelectric element regulator 19 at a position facing the upper end of the piezoelectric element 18. The piezoelectric element regulator 19 is in contact with the upper end of the piezoelectric element 18 and serves as a fixing point of the piezoelectric element 18.

The nozzle 14 serves as a discharge port or a nozzle hole, the nozzle plate 15 serves as a discharge port forming component, the needle valve 17 serves as the opening-closing valve (may be referred to simply as a valve), and the piezoelectric element 18 serves as a driver (movement device).

The channel 16 is shared with the multiple liquid discharge modules 30 in the housing 11 (see FIG. 2). A scaling member which is an elastic member is provided at the front end of the needle valve 17. The sealing member is supported by a needle of the needle valve 17. When the front end of the needle valve 17 is pressed against the nozzle plate 15, the sealing member is compressed so that the needle valve 17 reliably closes the nozzle 14. In the present embodiment, the pressing force of the needle valve 17 is 1 N in consideration of the sealing performance. As described below, a sealer 22 such as an O-ring is disposed between the housing 11 and the needle valve 17.

The piezoelectric element 18 is accommodated in a space (i.e., an accommodation space) inside the housing 11. The piezoelectric element 18 and the needle valve 17 are coaxially coupled to each other via the front end of a holder. The holder is coupled to the needle valve 17 on the front end side and is fixed by the piezoelectric element regulator 19 attached to the housing 11 on the rear end side.

When the drive controller 40 applies a voltage to the piezoelectric element 18, the piezoelectric element 18 contracts and pulls the needle valve 17 via the holder. Accordingly, the needle valve 17 moves away from the nozzle 14 to open the nozzle 14. Thus, the ink 150 pressurized and supplied to the channel 16 is discharged from the nozzle 14. When the drive controller 40 applies no voltage to the piezoelectric element 18, the needle valve 17 closes the nozzle 14. In this state, even if the ink 150 is pressurized and supplied to the channel 16, the ink 150 is not discharged from the nozzle 14.

The drive controller 40 includes a waveform generation circuit 41 serving as a drive pulse generator and an amplification circuit 42. The waveform generation circuit 41 generates a waveform of a drive pulse described later, and the amplification circuit 42 amplifies the voltage to a desired value. Then, the amplified voltage is applied to the piezoelectric element 18. The drive controller 40 applies the voltage to the piezoelectric element 18 to cause the piezoelectric element 18 to move the needle valve 17 to open and close the nozzle 14 so as to control a discharge operation of ink 150 from the liquid discharge head 10. When the waveform generation circuit 41 can apply a voltage of a sufficient value, the amplification circuit 42 may be omitted from the drive controller 40.

The waveform generation circuit 41 generates the drive pulse having a waveform in which the voltage applied to the piezoelectric element 18 is changed with time. The waveform generation circuit 41 receives print data from an external personal computer (PC) or a microcomputer in the liquid discharge apparatus, and generates a drive pulse based on the received print data. The waveform generation circuit 41 can change the voltage applied to the piezoelectric element 18 and generate multiple drive pulses. As described above, the waveform generation circuit 41 generates the drive pulse so that the piezoelectric element 18 expands and contracts in response to the drive pulse to move the needle valve 17 to open and close the nozzle 14.

### Comparative Example

Before detailed descriptions of a liquid discharge head according to embodiments of the present disclosure, comparative configurations (comparative examples) are described below. Then, embodiments of the present disclosure are described.

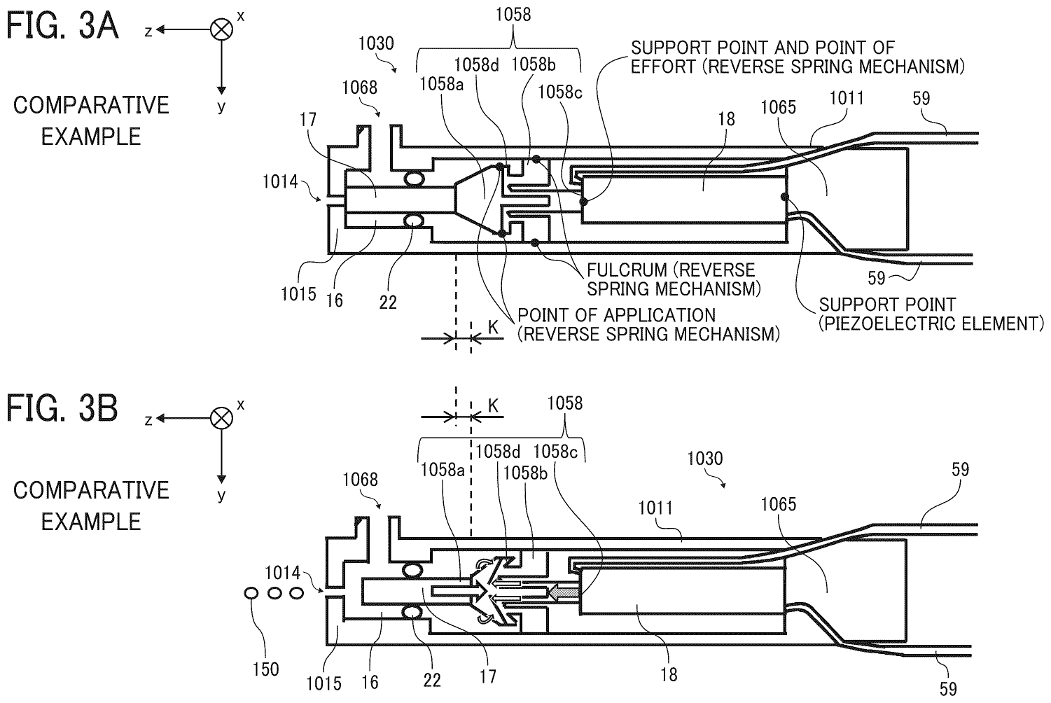

FIGS. 3A and 3B are diagrams each illustrating the configuration of a liquid discharge module according to a comparative example. FIGS. 3A and 3B are diagrams each illustrating a configuration of a lever type (reverse spring type) of a liquid discharge module 1030 according to the comparative example. FIG. 3A is a diagram illustrating a state in which the nozzle is closed, and FIG. 3B is a diagram illustrating a state in which the nozzle is opened.

The lever type uses the principle of leverage and includes a lever mechanism (reverse spring mechanism) that converts a stretching force of the piezoelectric element into a force for pulling the needle. In the lever type, the needle is moved in a direction opposite to the expansion-contraction direction of the piezoelectric element. Details of the leverage type configuration according to the comparative example will be described below.

As illustrated in FIG. 3A, an actuator unit (may be referred to simply as an actuator) as a drive mechanism is attached to a housing 1011. The actuator unit includes a reverse spring mechanism 1058 as a transmission mechanism between the needle having the needle valve 17 and the piezoelectric element 18. The reverse spring mechanism 1058 has an clastic body formed of, for example, rubber, soft resin, or thin metal plate which is appropriately processed, to be deformable. The reverse spring mechanism 1058 includes a deformable portion 1058a, a fixing portion 1058b, a guide portion 1058c, and a bent portion (bent side) 1058d.

The deformable portion 1058a has a substantially trapezoidal shape. The deformable portion 1058a contacts the base end of the needle (the right end of the needle in FIG. 3A). The fixing portion 1058b is fixed to the deformable portion 1058a and the inner wall of the housing 1011. The guide portion 1058c couples the fixing portion 1058b and the piezoelectric element 18. The bent portion 1058d couples the long side (end in the −z direction in FIG. 3A, corresponding to the lower base of the trapezoid) of the trapezoidal deformable portion 1058a and the fixing portion 1058b.

As described above, the reverse spring mechanism 1058 is also referred to as lever type. In the lever type, the guide portion 1058c is the point of effort of the reverse spring mechanism 1058, the joint between the fixing portion 1058b and the housing 1011 is the fulcrum of the reverse spring mechanism 1058, and the joint point between the bent side 1058d and the deformable portion 1058a is the point of application of the reverse spring mechanism 1058.

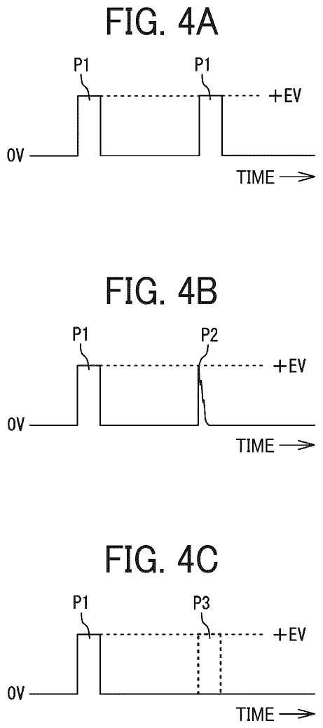

FIGS. 4A to 4C are diagrams each illustrating a timing chart of a voltage applied to the piezoelectric element. FIGS. 4A to 4C are waveform diagrams each illustrating a sample of a voltage applied to the piezoelectric element. In the present embodiment, a pulse P1 has a waveform having a predetermined voltage EV applied to the piezoelectric element 18 via lead wires 59. A pulse P2 has a waveform in which the predetermined voltage EV to be applied to the piezoelectric element 18 disappears in the middle of the pulse. A pulse P3 has a waveform in which no voltage is applied to the piezoelectric element due to, for example, a power failure. When the predetermined voltage EV is applied to the piezoelectric element 18, the piezoelectric element 18 expands. Even when the irregularities of voltage occur, for example, after the pulse P2 or P3 is applied to the piezoelectric element 18, the piezoelectric element 18 returns to the original state, similarly to when the voltage is normally applied and released. In the following description, the predetermined voltage EV is typically applied to the piezoelectric element 18.

In the reverse spring mechanism 1058 having the above-described configuration, when the predetermined voltage EV is applied to the piezoelectric element 18 as illustrated in FIG. 4A and the piezoelectric element 18 expands, the guide portion 1058c is pushed toward a nozzle 1014 (in the direction indicated by the black solid arrow in FIG. 3B, +z direction) by the expansion of the piezoelectric element 18. With this pushing force, the deformable portion 1058a is pulled in the direction away from the nozzle 1014 (in the direction indicated by the blank arrow in FIG. 3B, −z direction) due to the principle of leverage. In other words, the reverse spring mechanism 1058 converts the stretching force of the piezoelectric element 18 into the force for pulling the needle of the needle valve 17, and then transmits the force to the needle.

In the configuration according to the comparative example, by applying a voltage to the piezoelectric element 18, the piezoelectric element 18 expands, and accordingly, the needle valve 17, which serves as a valve body, moves by a distance K to open the nozzle 1014, and the ink 150 as a liquid (droplets) is discharged from the nozzle 1014. The ink 150 is supplied from an injection port 1068 of the housing 1011.

As described above, in the configuration according to the comparative example, the reverse spring mechanism 1058 is disposed between the needle and the piezoelectric element 18. The reverse spring mechanism 1058 converts the stretching force of the piezoelectric element 18 into the force for pulling the needle, i.e., a force opposite to the stretching force of the piezoelectric element 18, and then transmits the force to the needle.

In the above configuration, by applying the predetermined voltage EV to the piezoelectric element 18, the ink 150 as a liquid is discharged. When the predetermined voltage EV is not applied to the piezoelectric element 18, the needle valve 17 closes the nozzle 1014, and thus, the ink 150 is not discharged from the nozzle 1014 even when the pressurized liquid is supplied to the channel 16.

The reverse spring mechanism 1058 having the configuration according to the comparative example includes the fixing portion 1058b fixed to the housing 1011. As illustrated in FIG. 3A, the piezoelectric element 18 is supported by a piezoelectric element support 1065 at the end of the piezoelectric element 18 in the −z direction in FIG. 3A to fix the piezoelectric element 18. When the distance between the fixing portion 1058b and the support point of the piezoelectric element 18 varies for each nozzle due to component accuracy and assembly accuracy, the position of the needle valve 17 varies for each nozzle between channels (CH). As a result, the movement amount of the needle valve 17 varies among the channels. The variations in the movement amount of the needle valve 17 lead to variations in discharging performance among multiple nozzles.

The positional accuracy of the fixing portion 1058b and the support point of the piezoelectric element 18 is determined by the processing of the housing 1011. In a multi-nozzle discharge head having multiple nozzles and multiple piezoelectric elements, components of the discharge head are appropriately processed and assembled for each of the multiple nozzles to maintain the positional accuracy of the fixing portion 1058b and the support point of the piezoelectric element 18.

Each of the components such as the reverse spring mechanism 1058 and the piezoelectric element 18 also has a component tolerance. Accordingly, it is difficult to reduce the variations in discharging performance for each nozzle. In addition, unless the components such as the piezoelectric element 18, the reverse spring mechanism 1058, and the needle valve 17 are assembled into the housing 1011, the position and the displacement amount of the needle valve 17 are not measured or adjusted.

### Embodiments of the Present Disclosure

For this reason, the distance between the fixing portion and the support point of the piezoelectric element is preferably determined with a desired accuracy before the components are assembled into the housing. In view of the above situation, an actuator unit according to an embodiment of the present disclosure has the configuration described below. Details are described below.

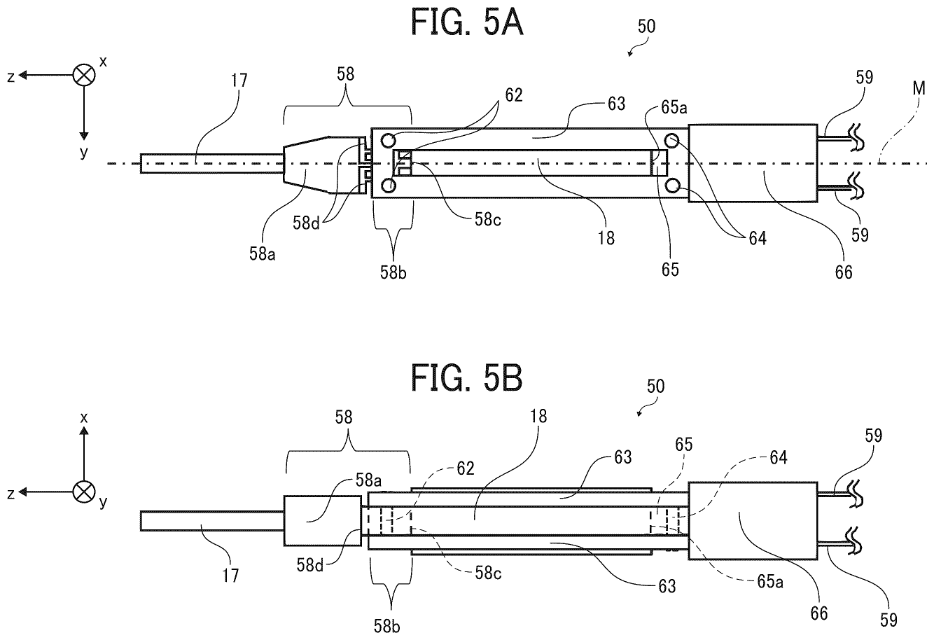

FIGS. 5A and 5B are diagrams each illustrating the actuator unit according to the present embodiment. In the present embodiment, the distance between the fixing portion of the movement mechanism (e.g., the reverse spring mechanism) and the support point of the piezoelectric element can be determined with a desired accuracy by a single component before the actuator unit serving as the drive mechanism is assembled into the housing. FIG. 5A is a diagram illustrating the actuator unit according to the present embodiment, and FIG. 5B is a diagram illustrating the actuator unit of FIG. 5A as viewed in the y direction. In the configuration according to the present embodiment, the components other than the reverse spring mechanism and the piezoelectric element support have the same configurations as those according to the comparative example.

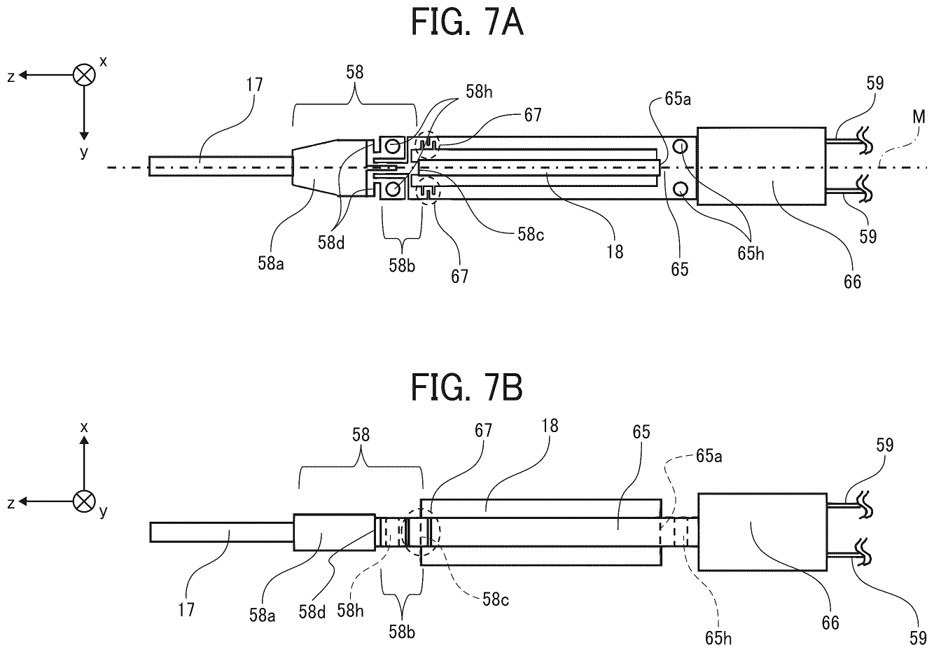

In FIG. 5A, an actuator unit 50 according to an embodiment of the present disclosure includes the needle valve 17, the piezoelectric element 18, and a plate-shaped piezoelectric element support 65. The piezoelectric element support 65 is fitted around the piezoelectric element 18 (see FIG. 7A). The actuator unit 50 further includes a movement mechanism 58 (i.e., the reverse spring mechanism) having a double-wing shape. The movement mechanism 58 is disposed at the front end of the piezoelectric element support 65 (i.e., at the end in the +z direction in FIG. 5A), adjacent to the needle valve 17. The movement mechanism 58 is line-symmetrical about a center line M of the piezoelectric element support 65 (i.e., the line parallel to the z direction in FIG. 5A). The movement mechanism 58 corresponds to an output portion of the actuator.

The actuator unit 50 includes a restrictor 63 fitted around the piezoelectric element support 65 and a part of the movement mechanism 58. The actuator unit includes a drive mechanism fixing member 66 that fixes the piezoelectric element support 65 and the restrictor 63, and a pair of lead wires 59 for voltage application connected to the electrodes of the piezoelectric element 18.

Further, as illustrated in FIG. 5B, the actuator unit 50 includes a first fixing member 62 as a fixing member and a second fixing member 64. The first fixing member 62 penetrates a fixing portion 58b of the movement mechanism 58 and the restrictor 63 to fix the movement mechanism 58 to the restrictor 63. The second fixing member 64 penetrates the piezoelectric element support 65 and the restrictor 63 to fix the piezoelectric element support 65 to the restrictor 63. The restrictor 63, the first fixing member 62, and the second fixing member 64 will be described later.

The movement mechanism 58 will be described below. The movement mechanism 58 has a function of opening and closing the needle valve 17 by moving a bent portion 58d toward the piezoelectric element 18 by a predetermined distance in accordance with the expansion and contraction amount of the piezoelectric element 18. In addition, as illustrated in FIG. 5A, the movement mechanism 58 includes the bent portion 58d that is a wing-shaped (double-wing shaped) component arranged line-symmetrically with respect to the center line M of the piezoelectric element support 65. A highly durable metal such as steel use stainless (SUS) is used as the material of the bent portion 58d of the movement mechanism 58. Examples of processing method for forming the movement mechanism 58 include wire cutting.

The movement mechanism 58 includes a deformable portion 58a serving as a valve mover. The deformable portion 58a is an elastic component formed of a deformable material such as rubber, soft resin, or thin metal plate. The deformable portion 58a has a trapezoidal shape. The deformable portion is attached to the end of the needle valve 17 on the piezoelectric element 18 side (i.e., the right side end of the needle valve 17 in FIG. 5A). In addition, the movement mechanism 58 includes the fixing portion 58b for fixing the movement mechanism 58, and a guide 58c coupled to the end of the piezoelectric element 18 via the piezoelectric element support 65 in the expansion-contraction direction. The long side (the end in the −z direction in FIG. 5A, corresponding to the lower base of trapezoid) of the trapezoidal deformable portion 58a is coupled to the fixing portion 58b, and is also coupled (joined) to the bent portion (bent side) 58d as a mover that moves toward the needle valve 17 relative to the fixing portion 58b in accordance with the expansion of the piezoelectric element 18.

An outline of an operation in the configuration of the movement mechanism 58 will be described below. Details will be described later.

In the movement mechanism 58 having such a configuration, when a predetermined voltage is applied to the piezoelectric element 18, the piezoelectric element 18 expands, so that the guide 58c moves toward the needle valve 17 (the +z direction in FIG. 5A). The guide 58c of the movement mechanism 58 presses the vicinity of the center of the bent portion 58d, and the movement mechanism 58 is deformed such that the outer edge (peripheral edge) of the bent portion 58d is pulled toward the piezoelectric element 18. Thus, the top (the end in the +2 direction in FIG. 5A, corresponding to the upper base of trapezoid) of the deformable portion 58a coupled to the needle valve 17 moves toward the piezoelectric element 18. As a result, the needle valve 17 is pulled toward the piezoelectric element 18 by a predetermined distance.

In addition, by appropriately adjusting the distance between the top of the deformable portion 58a and the bent portion 58d and the length of the bent portion 58d, the needle valve 17 can be moved by a distance longer than the length of expansion of the piezoelectric element 18. The deformable portion 58a of the movement mechanism 58 is coupled to the needle valve 17 at the top (the end in the +2 direction in FIG. 5A, corresponding to the upper base of trapezoid) of the deformable portion 58a.

The restrictor 63, the first fixing member 62, and the second fixing member 64 will be described below. The restrictor 63 is a single component, and has four reference points. As illustrated in FIG. 5B, the actuator unit 50 includes two restrictors 63. The two restrictors 63 sandwich the plate-shaped piezoelectric element support 65 from both sides in the x direction in FIG. 5B. Thus, the longitudinal direction (i.e., the z direction in FIG. 5B) of the restrictor 63 is parallel to the longitudinal direction (i.e., the z direction in FIG. 5B) of the piezoelectric element 18. Such an arrangement enhances the positional accuracy between the fixing portion 58b and a piezoelectric element support point 65a of the piezoelectric element support 65 at which the piezoelectric element 18 is supported. As described later, the restrictor 63 has a piezoelectric element opening 63c serving as an opening in which the piezoelectric element 18 is arranged. In FIG. 5B, the piezoelectric element 18 projects from the piezoelectric element opening 63c of the restrictor 63 in the x direction.

Further, the above-described four reference points of the restrictor 63 are fixing positions of the movement mechanism 58 and the first fixing member 62, and fixing positions of the piezoelectric element support 65 and the second fixing member 64. These four points minimize a change in the positional relationship between the portions of the actuator unit 50 due to a temperature change.

The first fixing member 62 and the second fixing member 64 have a function of fixing the restrictor 63, the piezoelectric element support 65, and the movement mechanism 58. The first fixing member 62 fixes the restrictor 63 and the fixing portion 58b, and prevents a fulcrum, which is a coupling point between the fixing portion 58b and the bent portion 58d (i.e., the mover), from rotating about the central axis of the first fixing member 62. Such a configuration can prevent the positional deviation of the fulcrum of the movement mechanism 58. The fulcrum will be described later in detail. The positions of the first fixing member 62 and the second fixing member 64 are the reference positions of the movement mechanism 58.

The shapes of the first fixing member 62 and the second fixing member 64 are the same as that of a typical rivet pin, and examples of the material thereof include metals having good workability for riveting, such as nickel silver. Examples of processing method for forming the first fixing member 62 and the second fixing member 64 include cutting by which fixing members are easily formed.

As illustrated in FIGS. 5A and 5B, the first fixing member 62 fixes the position of the fixing portion 58b of the movement mechanism 58, and is integrated with the movement mechanism 58 to prevent the positional deviation of the fulcrum of the movement mechanism 58 which is described later. As illustrated in FIGS. 5A and 5B, the second fixing member 64 fixes the position of the piezoelectric element support 65. The restrictor 63 regulates a distance between the fixing portion 58b and the piezoelectric element support point 65a at which the piezoelectric element 18 is supported by the piezoelectric element support 65. With such a configuration, the distance between the fixing portion 8b and the piezoelectric element support point 65a can be determined with a desired accuracy by a single component before the actuator unit 50 is assembled into the housing 11 of the liquid discharge module 30. In other words, in the present embodiment, a fixing shaft (e.g., the first fixing member 62) that determines the position of the fixing portion 58b and the fixing shaft (e.g., the second fixing member 64) that determines the position of the piezoelectric element support point 65a at which the piezoelectric element 18 is supported, can be positioned with a desired accuracy by a single component such as the restrictor 63. In other words, the restrictor 63 can be specialized in the function of regulating the positions of the fixing portion 58b to the piezoelectric element support point 65a. Accordingly, the restrictor 63 can be formed in a suitable shape with a suitable material by a suitable processing method to regulate these positions.

In addition, with such a configuration described above, before the actuator unit 50 is assembled into the housing 11 of the liquid discharge module 30, the distance to the front end of the needle valve 17 and the movement amount (lift amount) of the needle valve 17 when the piezoelectric element 18 is driven can be measured, inspected, and adjusted. As a result, a desired accuracy can be easily obtained as compared with a case where an accuracy is obtained by assembling an actuator into a liquid discharge head having multiple nozzles, and thus the assembly of the actuator unit can be facilitated.

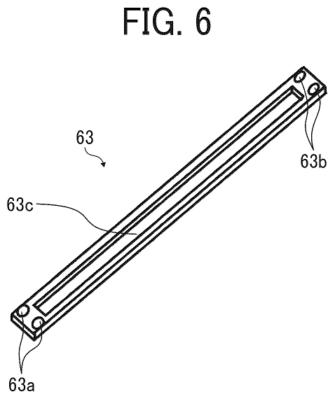

FIG. 6 is a diagram illustrating the external appearance of a restrictor according to an embodiment of the present disclosure. The configuration of the restrictor will be described below more specifically with reference to FIG. 6. In order to dissipate heat generated in the piezoelectric element 18 to the outside, the restrictor 63 has a rectangular parallelepiped shape having the piezoelectric element opening 63c (opening) that is the cutout, at the center, having an area larger than the outer dimensions of the piezoelectric element 18. The piezoelectric element 18 is arranged in the piezoelectric element opening 63c. The piezoelectric element opening 63c has an area at minimum with which the restrictor 63 does not contact the piezoelectric element 18.

The restrictor 63 is made of, for example, a metal material having a small coefficient of thermal expansion (thermal expansion coefficient) such as INVAR material (e.g., a material which is an alloy of Fe and Ni, and has a linear expansion coefficient of 0 in a specific temperature range). Examples of processing method for forming the restrictor 63 include cutting. The restrictor 63 is fitted around the piezoelectric element support 65 and a part of the movement mechanism 58.

As illustrated in FIG. 6, the restrictor 63 has a first fixing member insertion hole 63a into which the first fixing member 62 is inserted and a second fixing member insertion hole 63b into which the second fixing member 64 is inserted. The first fixing member 62 is inserted into the first fixing member insertion hole 63a, and the second fixing member 64 is inserted into the second fixing member insertion hole 63b. The plate-shaped piezoelectric element support 65, the movement mechanism 58, and the restrictor 63 are fixed by the first fixing member 62 and the second fixing member 64. Such a configuration minimizes a change due to a temperature change in the positional relationship between the piezoelectric element support point 65a at which the piezoelectric element 18 is supported and a fulcrum (the coupling point between the fixing portion 58b and the bent portion 58d of the movement mechanism 58) to be described later.

The restrictor 63 is preferably formed as a single component. The reason for this is as follows. If the restrictor 63 is a combined component of multiple (e.g., two or more) parts, the restrictor 63 has component tolerances corresponding to the multiple parts. Accordingly, the component tolerances of the restrictor 63 corresponding to the multiple parts may reduce the positional accuracy between the fixing portion 58b and the piezoelectric element support point 65a, which may lead to the variations in the movement amount of the needle valve and the variations in discharging performance among nozzles. Thus, the restrictor 63 is preferably formed as a single component to reduce such variations.

FIGS. 7A and 7B are diagrams each illustrating an actuator unit from which a restrictor is removed according to an embodiment of the present disclosure. FIG. 7A illustrates the actuator unit from which the restrictor is removed, and FIG. 7B is a diagram of the actuator unit of FIG. 7A as viewed in the y direction. In other words, FIGS. 7A and 7B are diagrams each illustrating the actuator unit of FIGS. 5A and 5B from which the restrictor 63 according to the present embodiment is removed.

As illustrated in FIG. 7A, the piezoelectric element support 65 accommodates the piezoelectric element 18. One end of the piezoelectric element 18 is fixed at the piezoelectric element support point 65a. The guide 58c of the movement mechanism 58 is coupled to the other end of the piezoelectric element 18 via the piezoelectric element support 65. In other words, a space for accommodating the piezoelectric element 18 can be formed between the guide 58c and the piezoelectric element support point 65a. The piezoelectric element 18 and the needle valve 17 are coupled to each other on the center line M (the line parallel to the z direction in FIG. 7A) of the piezoelectric element support 65 via the piezoelectric element support 65 and the movement mechanism 58. Thus, the piezoelectric element support 65 supports the expansion and contraction of the piezoelectric element 18. In other words, the piezoelectric element support 65 expands and contracts with the expansion and contraction of the piezoelectric element 18.

As illustrated in FIG. 7A, the fixing portion 58b of the movement mechanism 58 has an insertion hole 58h in the vicinity of the guide 58c. The piezoelectric element support 65 has an insertion hole 65h in the vicinity of the piezoelectric element support point 65a. As illustrated in FIG. 7B, the insertion hole 58h penetrates the fixing portion 58b of the movement mechanism 58 in the x direction. The first fixing member 62 is inserted into the insertion hole 58h to fix the movement mechanism 58 to the restrictor 63. As illustrated in FIG. 7B, the insertion hole 65h penetrates the piezoelectric element support 65 in the x direction. The second fixing member 64 is inserted into the insertion hole 65h to fix the piezoelectric element support 65 to the restrictor 63.

The piezoelectric element support 65 includes spring portions (i.e., elastic portions) 67 that are elastically deformable toward the guide 58c. The spring portions 67 are bilaterally symmetrical (arranged in the y direction in FIG. 7A) about the center line M (the line parallel to the z direction in FIG. 7A). The guide 58c of the movement mechanism 58 is coupled to the piezoelectric element support 65 near the spring portions 67.

Each of the spring portions 67 of the piezoelectric element support 65 has alternate slits extending in the direction orthogonal to the longitudinal direction of the piezoelectric element support 65 (i.e., the y direction in FIG. 7A) to form a crankshaft shape (zigzag). Thus, the spring portions 67 have a spring function.

The spring portion 67 is disposed in parallel with the longitudinal direction (the z direction in FIG. 7A) of the piezoelectric element 18 and the center line M. Thus, the spring portions 67 generate a force (biasing force) of the spring depending on the shape of the piezoelectric element 18. Thus, the biasing force of the spring portions 67 is generated in synchronization with the expansion and contraction (displacement) of the piezoelectric element 18 when a voltage is applied to the piezoelectric element 18. Thus, the spring portions 67 can be elastically deformed such that the piezoelectric element support 65 expands and contracts in accordance with the expansion and contraction of the piezoelectric element 18. In the present embodiment, the spring portions 67 have the same or substantially the same spring constant.

As described above, the piezoelectric element support 65 is fitted around the piezoelectric element 18, and the guide 58c of the movement mechanism 58 is coupled to the piezoelectric element support 65. Thus, the piezoelectric element support 65 including the spring portions 67 is integrated with the movement mechanism 58 to form a single unit. The piezoelectric element support 65 has a plate shape, and a highly durable metal such as SUS is used as the material of the piezoelectric element support 65. Examples of processing method for forming the piezoelectric element support 65 include wire cutting.

A length of a space between the support points of the piezoelectric element 18 in the piezoelectric element support 65 (between one end of the space on the guide member 85c side and the other end of the space on the piezoelectric element support point 65a side) is shorter than the length of the piezoelectric element 18 (the size of the piezoelectric element 18 in the z direction). As a result, when the piezoelectric element 18 is fitted into the space between the support points of the piezoelectric element 18 in the piezoelectric element support 65 (between one end of the space on the guide member 85c side and the other end of the space on the piezoelectric element support point 65a side), the spring portions 67 of the piezoelectric element support 65 stretch, and thus, the length of the space between the support points of the piezoelectric element 18 in the piezoelectric element support 65 (between one end of the space on the guide member 85c side and the other end of the space on the piezoelectric element support point 65a side) is extended by a difference between the original length of the space and the length of the piezoelectric element 18 (the size of the piezoelectric element 18 in the z direction).

In the present embodiment, the movement mechanism 58 and the piezoelectric element support 65 having the spring portions 67 are integrally formed as a single unit. Thus, the actuator unit 50 can be downsized.

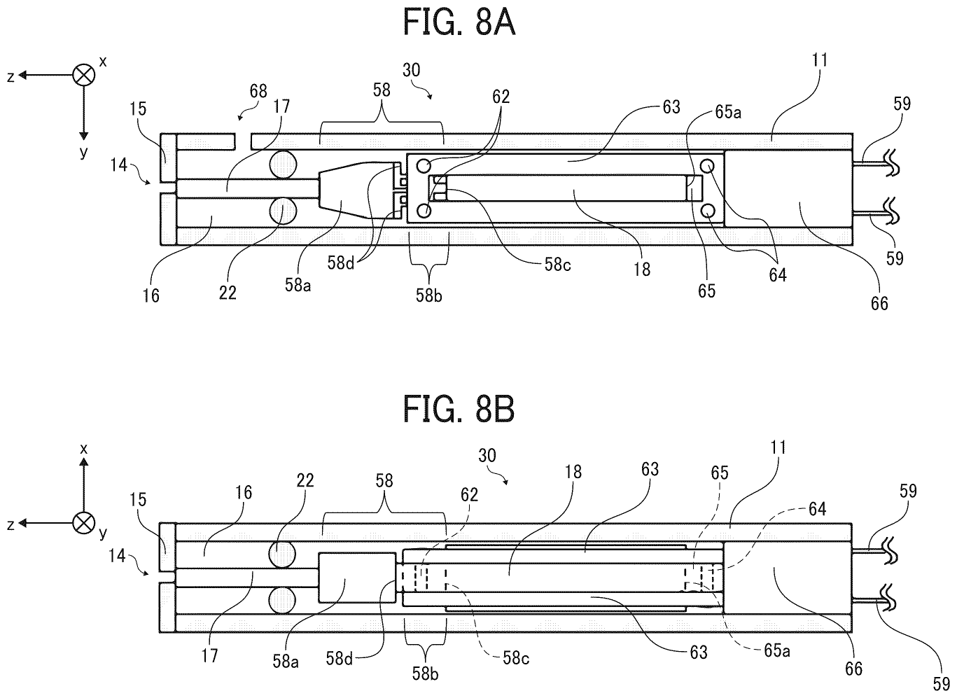

FIGS. 8A and 8B are diagrams each illustrating a configuration of a liquid discharge module according to an embodiment of the present disclosure. FIG. 8A is a diagram illustrating an actuator unit attached into a housing according to the present embodiment, and FIG. 8B is a diagram illustrating the actuator unit of FIG. 8A as viewed in the y direction. In other words, FIGS. 8A and 8B are diagrams each illustrating the actuator unit of FIGS. 5A and 5B which is attached into the housing.

As illustrated in FIG. 8A, the liquid discharge module 30 includes the nozzle plate 15 on the front end side in the +z direction in FIG. 8A. The nozzle plate 15 has the nozzle 14 from which the ink 150 as a liquid is discharged. The housing 11 of the liquid discharge module 30 has an injection port 68 for supplying the ink 150. The actuator unit (e.g., the actuator unit 50 in FIGS. 5A and 5B), which is the drive mechanism described above, is attached into the hollow space of the housing 11. At this time, the front end of the needle valve 17 is disposed on the nozzle 14 side.

In the liquid discharge module 30, the drive mechanism fixing member 66 for fixing the piezoelectric element support 65 is fixed to the housing 11. The sealer 22 such as the O-ring described above is disposed between the housing 11 and the needle valve 17. The sealer 22 prevents the ink 150 from entering the space on the piezoelectric element 18 side.

As can be seen in FIGS. 8A and 8B, the restrictor 63 is not fixed to the housing 11 and has a predetermined clearance. As illustrated in FIGS. 8A and 8B, the fixing portion 58b of the movement mechanism 58 according to the present embodiment is not fixed to the housing 11, and is fixed by the restrictor 63.

### Operation of Actuator Unit According to the Present Embodiment

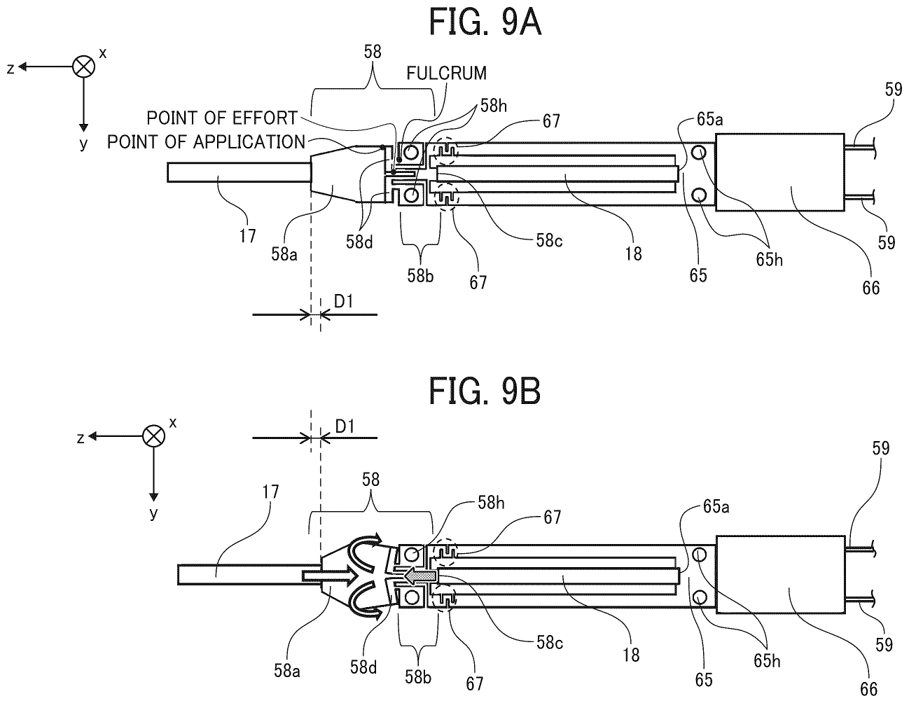

FIGS. 9A and 9B are diagrams each illustrating an operation of an actuator unit according to an embodiment of the present disclosure. FIG. 9A illustrates the actuator unit when a predetermined voltage is not applied, and FIG. 9B illustrates the actuator unit when the predetermined voltage is applied. FIGS. 9A and 9B illustrate a configuration of the actuator unit from which the restrictor 63 according to the present embodiment is removed. Descriptions are given below of the states of the actuator unit before and after the movement mechanism moves the needle valve, and the fulcrum, the point of effort, and the point of application of the movement mechanism using the principle of leverage with reference to FIGS. 9A and 9B.

In FIG. 9A, the joint point between the guide 58c and the bent portion 58d of the movement mechanism 58, which is the reverse spring mechanism, serves as the point of effort. A portion of the movement mechanism 58 in the vicinity of the central axis of the first fixing member 62 serves as the fulcrum of the movement mechanism 58, and the joint point between the deformable portion 58a and the bent portion (bent side) 58d in the movement mechanism 58 serves as the point of application of the movement mechanism 58. When the predetermined voltage EV is applied to the piezoelectric element 18 via the lead wires 59, the piezoelectric element 18 expands in the direction indicated by the black solid arrow in FIG. 9B (the +z direction in FIG. 9B). Due to the principle of leverage, the bent portion 58d and the deformable portion 58a in the movement mechanism 58 are deformed in a manner of being pulled to the piezoelectric element 18 side in the direction indicated by the blank arrows in FIG. 9B (the −z direction in FIG. 9B).

Thus, the top (the end in the +z direction in FIG. 9A, corresponding to the upper base of trapezoid) of the deformable portion 58a coupled to the needle valve 17 moves toward the piezoelectric element 18. As a result, as illustrated in FIG. 9B, the needle valve 17 is pulled toward the piezoelectric element 18 by a distance D1.

FIGS. 10A and 10B are diagrams each illustrating an operation of a liquid discharge module according to an embodiment of the present disclosure. FIG. 10A illustrates the liquid discharge module when a predetermined voltage is not applied, and FIG. 10B illustrates the liquid discharge module when the predetermined voltage is applied. In other words, FIGS. 10A and 10B are diagrams each illustrating the liquid discharge module to which the actuator unit having the configuration of FIGS. 9A and 9B is applied.

As described above, when the predetermined voltage EV is applied to the piezoelectric element 18 and the top (the end in the +z direction in FIG. 10A, corresponding to the upper base of trapezoid) of the deformable portion 58a coupled to the needle valve 17 moves toward the piezoelectric element 18, the needle valve 17 is pulled toward the piezoelectric element 18 by the distance D1. In the liquid discharge module 30, as illustrated in FIG. 10B, the needle valve 17 moves toward the piezoelectric element 18 by the distance D1 to open the nozzle 14. As a result, the pressurized liquid supplied to the channel 16 is discharged from the nozzle 14.

With the above configuration, when the predetermined voltage EV is applied to the piezoelectric element 18 via the lead wires 59, the needle valve 17 moves in an opening direction (the −z direction in FIG. 10B) to open the nozzle 14. Accordingly, when the predetermined voltage EV is not applied to the piezoelectric element 18, the needle valve 17 closes the nozzle 14, and thus, the liquid is not discharged from the nozzle 14 even when the pressurized liquid is supplied to the channel 16.

### Details of Operation of Movement Mechanism

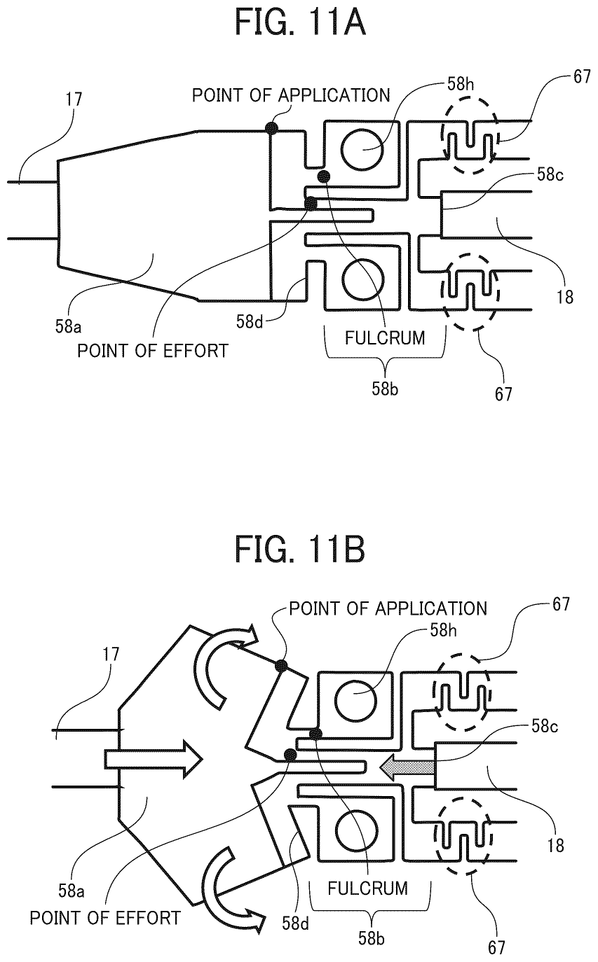

FIGS. 11A and 11B are diagrams each illustrating details of a movement mechanism according to an embodiment of the present disclosure. FIG. 11A illustrates an actuator unit when a predetermined voltage is not applied, and FIG. 11B illustrates the actuator unit when the predetermined voltage is applied. In FIGS. 11A and 11B, illustrations of a portion of the movement mechanism 58 and the piezoelectric element support 65 in the actuator unit according to the present embodiment is enlarged. Descriptions are given below in detail of the states of the actuator unit before and after the movement mechanism moves the needle valve, and the fulcrum, the point of effort, and the point of application of the movement mechanism with reference to FIGS. 11A and 11B, focusing on the movement mechanism.

As illustrated in FIG. 11A, the coupling point between the fixing portion 58b and the bent portion (bent side) 58d of the movement mechanism 58 is the fulcrum of the movement mechanism 58. The insertion hole 58h is disposed in the vicinity of the fulcrum to fix the position of the fulcrum. The first fixing member 62 is inserted into the insertion hole 58h of the fixing portion 58b to fix the movement mechanism 58.

The joint point between the bent portion 58d and the deformable portion 58a in the movement mechanism 58 is the point of application of the movement mechanism 58. The joint point between the end of the guide 58c on the needle valve 17 side in the +2 direction in FIG. 11A and the bent portion 58d is the point of effort.

With this configuration, when the predetermined voltage EV is applied to the piezoelectric element 18 via the lead wires 59, the piezoelectric element 18 expands in the direction indicated by the black solid arrow in FIG. 11B (the +z direction in FIG. 11B). As a result, a force acts on the bent portion 58d via the point of effort, and the bent portion 58d is deformed in a manner of being pulled toward the piezoelectric element 18 in the direction indicated by the blank arrows in FIG. 11B (the −z direction in FIG. 11B) with the fulcrum as an axis due to the principle of leverage. Accordingly, the point of application is moved by the deformation, the deformable portion 58a coupled to the needle valve 17 is also deformed in a manner of being pulled to the piezoelectric element 18, and the top (the end in the +2 direction in FIG. 11A, corresponding to the upper base of trapezoid) of the deformable portion 58a moves toward the piezoelectric element 18. Thus, the needle valve 17 coupled to the deformable portion 58a is pulled toward the piezoelectric element 18.

When the above configuration is adopted, in the present embodiment, the needle valve 17 can be moved largely with small expansion and contraction of the piezoelectric element 18. For example, when the “distance from the point of application to the fulcrum” is twice the “distance from the fulcrum to the point of effort,” the movement amount of the needle valve 17 is twice the expansion amount of the piezoelectric element 18. In other words, in the present embodiment, the movement mechanism 58 having the above-described configuration can convert a small expansion amount of the piezoelectric element 18 into a large movement amount of the needle valve 17 due to the principle of leverage.

As described above, the actuator unit according to the present embodiment has a configuration in which, when a predetermined voltage is applied to the piezoelectric element, the distance of movement of the needle valve is longer than the length of expansion of the piezoelectric element. With this configuration, the piezoelectric element can be downsized, leading to cost reduction.

### Influence of Positional Deviation of Fulcrum on Movement Amount of Needle Valve

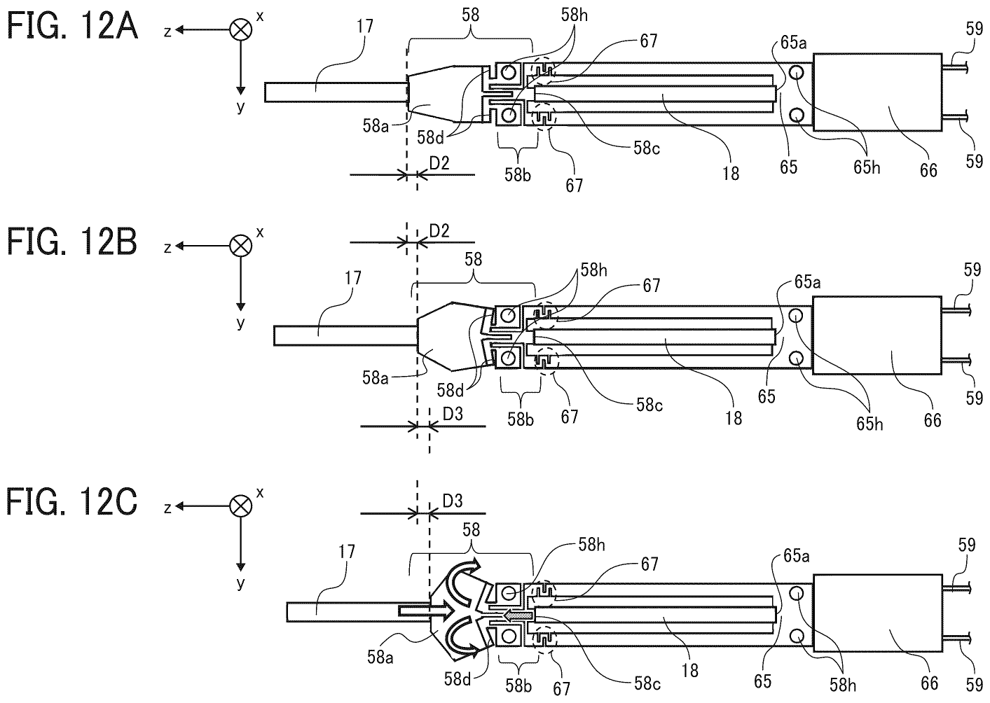

In the present embodiment, the assembly of the fixing portion related to the position of the fulcrum may affect the movement amount of the needle valve. FIGS. 12A to 12C are diagrams each illustrating the influence of a positional deviation of a fulcrum on the movement amount of a needle valve according to an embodiment of the present disclosure. With reference to FIGS. 12A to 12C, the influence of the positional deviation of the fulcrum on the movement amount of the needle valve will be described below.

FIG. 12A is a diagram illustrating the actuator unit in which the fixing portion is assembled without the position deviation of the fulcrum from a predetermined position. On the other hand, FIG. 12B is a diagram illustrating the actuator unit in which the fixing portion is assembled with the positional deviation of the fulcrum from the predetermined position. In FIG. 12B, the fulcrum is assembled with the positional deviation of, for example, a distance Δd from the predetermined position toward the piezoelectric element 18 (the −z direction in FIG. 12B) as compared with the fulcrum in FIG. 12A. At this time, the positional deviation may cause the deformable portion 58a and the bent portion 58d to be deformed. As a result, the needle valve 17 may be pulled toward the piezoelectric element 18 and moved toward the piezoelectric element 18. In other words, the needle valve 17 may be moved similarly to when a specific voltage is applied to the piezoelectric element 18. At that time, a movement amount D2 of the needle valve 17 may be considerably larger than the distance Δd because the relationship between the “distance between the fulcrum and the point of effort” and the “distance between the fulcrum and the point of application” also changes due to the influence of the change in the position of the fulcrum.

FIG. 12C is a diagram illustrating the actuator unit when the predetermined voltage EV is applied to the piezoelectric element 18 of the actuator unit of FIG. 12B. In FIG. 12B, when the predetermined voltage EV is applied to the piezoelectric element 18 via the lead wires 59, the piezoelectric element 18 expands in the direction indicated by the black solid arrow in FIG. 12C (the +z direction in FIG. 12C). As a result, a force acts on the bent portion 58d via the point of effort, and the bent portion 58d is deformed in a manner of being pulled toward the piezoelectric element 18 in the direction indicated by the blank arrows in FIG. 12C (the −z direction in FIG. 12C) with the fulcrum as an axis due to the principle of leverage. Thus, the point of application is moved, and the needle valve 17 coupled to the deformable portion 58a is pulled toward the piezoelectric element 18 and moved by a movement amount D3 toward the piezoelectric element 18. In this case, the needle valve 17 is moved from the position at which the fulcrum deviates toward the piezoelectric element 18. The movement amount D3 at this time is based on the position of FIG. 12B.

As illustrated in FIG. 12C, when the fixing portion 58b is assembled with the positional deviation of the fulcrum from the predetermined position, the needle valve 17 is moved by the movement amount D2+D3 by applying the predetermined voltage as compared with the position of FIG. 12A. In other words, the fixing portion fixed with the positional deviation of the fulcrum may greatly change the movement amount of the needle valve as compared with the desired movement amount. The positional deviation may greatly affect the variations in the movement amount of the needle valve among the nozzles in the liquid discharge head including the multiple nozzles, and thus also affect the variations in discharging performance among the nozzles. Accordingly, from the viewpoint of preventing such variations, the fixing portion of the movement mechanism is preferably assembled at a predetermined position with high accuracy.

As described above, according to the present embodiment, an actuator unit includes the piezoelectric element 18, the valve body (e.g., the needle valve 17) that is movable in the expansion-contraction direction of the piezoelectric element 18, the piezoelectric element support 65 that supports one end of the piezoelectric element 18 in the expansion-contraction direction, and the movement mechanism 58 that is coupled to the valve body (e.g., the needle valve 17) and the other end of the piezoelectric element 18 in the expansion-contraction direction and moves the valve body in accordance with the expansion of the piezoelectric element 18. The movement mechanism 58 includes the fixing portion 58b whose position is fixed with respect to the piezoelectric element support 65, and the actuator unit includes the restrictor 63 that regulates the position of the fixing portion 58b with respect to the piezoelectric element support 65. Such a configuration reduces the variations in the movement amount of the valve body.

Furthermore, as described above, in the present embodiment, the movement mechanism 58 includes the mover (e.g., the bent portion 58d) that is coupled to the piezoelectric element 18 and moves toward the valve body (e.g., the needle valve 17) with respect to the fixing portion 58b in accordance with the expansion of the piezoelectric element 18, and the valve mover (e.g., the deformable portion 58a) that moves the valve body (e.g., the needle valve 17) toward the piezoelectric element 18 with respect to the fixing portion 58b in accordance with the movement of the mover (e.g., the bent portion 58d). Such a configuration can greatly move the needle valve as the valve body with a small amount of expansion of the piezoelectric element, and the piezoelectric element can be downsized, leading to cost reduction.

Furthermore, as described above, in the present embodiment, the longitudinal direction of the restrictor 63 is parallel to the longitudinal direction of the piezoelectric element 18. Such a configuration can enhance the positional accuracy between the fixing portion of the movement mechanism and the piezoelectric element support.

Furthermore, as described above, in the present embodiment, the restrictor 63 is formed of a single component. Such a configuration prevents the variations in the movement amount of the needle valve caused by a decrease in the positional accuracy between the fixing portion of the movement mechanism and the piezoelectric element support due to component tolerances.

Furthermore, as described above, in the present embodiment, the actuator unit includes the fixing member (e.g., the first fixing member 62) that fixes the restrictor 63 and the fixing portion 58b, and the coupling point between the fixing portion 58b and the mover (e.g., the bent portion 58d) does not rotate about the central axis of the fixing member (e.g., the first fixing member 62). Such a configuration can prevent the positional deviation of the fulcrum of the movement mechanism.

Furthermore, as described above, in the present embodiment, the movement mechanism 58 and the fixing member 62 are integrated to form a single body. Such a configuration can enhance the positional accuracy between the fixing portion of the movement mechanism and the piezoelectric element support.

Furthermore, as described above, in the present embodiment, when a predetermined voltage is applied to the piezoelectric element 18, the distance of movement of the valve body (e.g., the needle valve 17) is longer than the length of expansion of the piezoelectric element 18. Such a configuration can downsize the piezoelectric element, leading to cost reduction.

Furthermore, as described above, in the present embodiment, the actuator unit includes at least two restrictors 63, and the fixing portion 58b is fixed by being sandwiched by at least two restrictors 63. Such a configuration can enhance the positional accuracy between the fixing portion of the movement mechanism and the piezoelectric element support.

Furthermore, as described above, in the present embodiment, the actuator unit includes an elastic member (e.g., the spring portion 67) that is coupled to the mover (e.g., the bent portion 58d) on one side and coupled to the piezoelectric element support 65 on the other side to bias the mover (e.g., the bent portion 58d) toward the piezoelectric element 18. Such a configuration generates the biasing force of the elastic member in synchronization with the expansion and contraction (displacement) when a voltage is applied to the piezoelectric element.

Further, as described above, in the present embodiment, the piezoelectric element support 65, the clastic member (e.g., the spring portion 67), and the movement mechanism 58 are included in a single unit. Such a configuration can downsize the actuator unit.

Further, as described above, in the present embodiment, the restrictor 63 has the opening 63c in the region corresponding to the side of the piezoelectric element 18. Such a configuration can dissipate heat generated in the piezoelectric element to the outside.

### Coefficient of Thermal Expansion of Restrictor

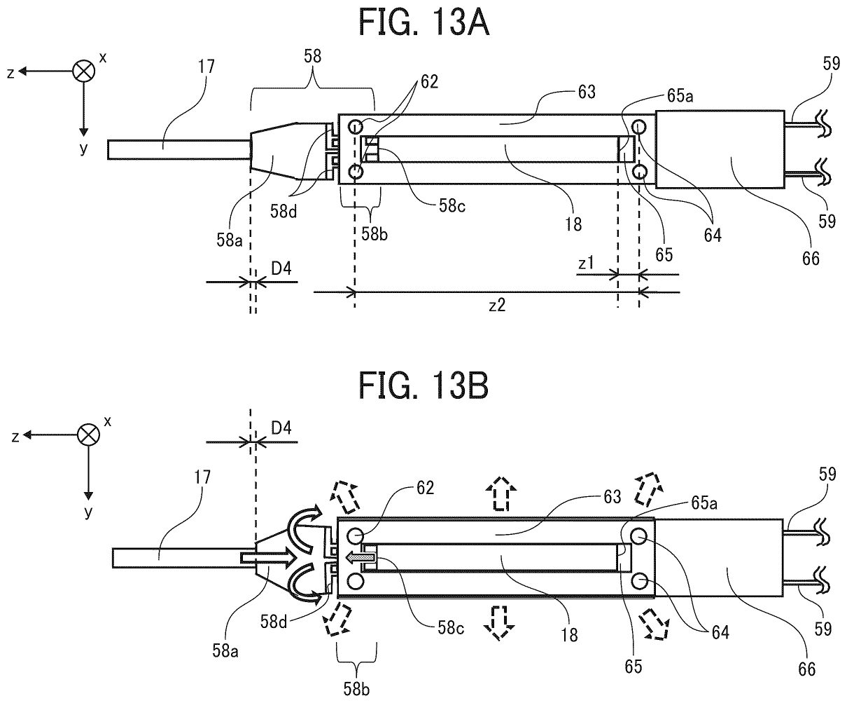

The actuator unit as the drive mechanism is affected by heat from the inside and the outside such as heat of the outside air and heat generated from the piezoelectric element, which may cause thermal expansion. The thermal expansion affects, for example, the movement of the needle valve. Thus, the coefficient of thermal expansion of the restrictor according to the present embodiment may affect the movement of the needle valve. The coefficient of thermal expansion of the restrictor will be described below in detail. FIGS. 13A and 13B are diagrams each illustrating the influence of the coefficient of thermal expansion of a restrictor according to an embodiment of the present disclosure on the movement amount of a needle valve. FIG. 13A illustrates an actuator unit according to an embodiment of the present disclosure before thermal expansion occurs, and FIG. 13B illustrates the actuator unit of FIG. 13A when thermal expansion has occurred.

As illustrated in FIG. 13B, when the actuator unit is driven, the piezoelectric element 18 in the drive mechanism generates heat. Accordingly, the generated heat is transferred to the piezoelectric element support 65 coupled to the piezoelectric element 18, the movement mechanism 58, the restrictor 63, the first fixing member 62, and the second fixing member 64. As a result, each of those components thermally expands, and the volume of each of those components increases.

Thus, the joint point (the point of application of the movement mechanism 58 as the reverse spring mechanism) between the bent portion (bent side) 58d and the deformable portion 58a of the movement mechanism 58, the joint point (the point of effort of the movement mechanism 58) between the guide 58c and the bent portion (bent side) 58d of the movement mechanism 58, and the positions of the first fixing member 62 and the second fixing member 64 as the reference positions of the piezoelectric element support 65 and the movement mechanism 58 are greatly changed. As a result, the piezoelectric element 18 is deformed in the direction indicated by the dashed blank arrows illustrated in FIG. 13B even if a specific voltage is not applied to the piezoelectric element 18. The bent portion 58d and the deformable portion 58a in the movement mechanism 58 may be deformed in a manner of being pulled toward the piezoelectric element 18. As a result, the top (the end in the +2 direction in FIG. 13A, corresponding to the upper base of trapezoid) of the deformable portion 58a coupled to the needle valve 17 may move toward the piezoelectric element 18, and for example, the needle valve 17 is pulled toward the piezoelectric element 18 by a distance D4 illustrated in FIG. 13B, causing the needle valve 17 to open the nozzle 14. As a result, even if a specific voltage is not applied to the piezoelectric element 18, the pressurized liquid supplied to the channel 16 may be discharged from the nozzle 14, and thus ink leakage or adhesion of the ink 150 around the nozzle 14 may occur.

In order to prevent the thermal expansion, the restrictor 63 according to the present embodiment is made of a metal having a small coefficient of thermal expansion, such as INVAR material (e.g., a material which is an alloy of Fe and Ni, and has a linear expansion coefficient of 0 in a specific temperature range). Thus, even when the piezoelectric element 18 generates heat due to driving, the restrictor 63 having the reference positions of the piezoelectric element support 65 and the movement mechanism 58 is fixed integrally with the first fixing member 62, the second fixing member 64, the piezoelectric element support 65, and the movement mechanism 58 to form a single unit. Thus, even if each component coupled to the piezoelectric element 18 thermally expands, the above-described problem can be prevented.

The settings of the coefficient of thermal expansion of the restrictor 63 compared to that of the piezoelectric element support will be described below with reference to FIG. 13A. The coefficient of thermal expansion of the restrictor 63 is preferably smaller than that of the piezoelectric element support 65 to which the restrictor 63 is fixed and that of the piezoelectric element 18 that generates heat due to driving. In particular, the coefficient of thermal expansion of the restrictor 63 is preferably smaller than the coefficient of thermal expansion of the piezoelectric element support 65, which is in direct contact with the restrictor 63. The reason for this is explained below. The description will be given below on the assumption that the coefficient of thermal expansion of the restrictor is set to a value equal to or close to the coefficient of thermal expansion of the piezoelectric element support 65 or the movement mechanism 58.

As illustrated in FIG. 13A, a distance from the piezoelectric element support point 65a to the fixing portion of the second fixing member 64 is z1, and a distance from the first fixing member 62 to the fixing portion of the second fixing member 64 is 22. It is assumed that the distance 22 is 20 times the distance z1. At this time, it is assumed that the piezoelectric element support 65 expands in the longitudinal direction (the z direction in FIG. 13A) of the piezoelectric element support 65 due to thermal expansion. Thus, in the relationship of the displacement amount due to the expansion, the displacement amount of the distance z2 is, for example, about 20 times as large as the displacement amount of the distance z1. The influence of the displacement amount leads to the positional deviation of the fulcrum as described with reference to FIGS. 12A to 12C, and further affects the relationship between the “distance between the fulcrum and the point of effort” and the “distance between the fulcrum and the point of application.” As a result, the movement amount of the needle valve 17 is also affected, and the desired discharging performance is not obtained.

Accordingly, in order to prevent such thermal expansion, the restrictor 63 according to the present embodiment has the coefficient of the thermal expansion, at least, smaller than the coefficient of the thermal expansion of the piezoelectric element support 65 to prevent the above-described problem. Further, as described above, the restrictor 63 according to the present embodiment is made of a metal having a small coefficient of thermal expansion, such as INVAR material (e.g., a material which is an alloy of Fe and Ni, and has a linear expansion coefficient of 0 in a specific temperature range), and thus, the expansion of the piezoelectric element support 65 due to thermal expansion can be effectively prevented.

The specific coefficient of thermal expansion of the restrictor 63 may be determined by, for example, the relationship between the distance from the piezoelectric element support point 65a to the fixing portion of the second fixing member 64 and the distance from the first fixing member 62 to the fixing portion of the second fixing member 64. In the embodiment illustrated in FIG. 13A, the displacement amount of the distance 22 from the first fixing member 62 to the fixing portion of the second fixing member 64 is about 20 times the displacement amount of the distance z1 from the piezoelectric element support point 65a to the fixing portion of the second fixing member 64. Accordingly, the coefficient of the thermal expansion of the restrictor 63 may be set to about 1/20 of the coefficient of the thermal expansion of the piezoelectric element support 65.

As described above, in the present embodiment, the restrictor 63 is formed of a metal having a smaller coefficient of thermal expansion than, at least, the piezoelectric element support 65. Such a configuration can reduce the variations in the movement amount of the needle valve.

As described above, in the present embodiment, the position of the fixing portion of the movement mechanism, which serves as the reverse spring mechanism, in the actuator unit and the position of the piezoelectric element support of the piezoelectric element are fixed by the restrictor. Such a configuration can enhance the assemblability of the actuator unit to the liquid discharge head. The enhancement of assemblability reduces the variations in the movement amount of the needle valve, and further reduces the variations in discharging performance (the amount and velocity of liquid droplets) among the multiple nozzles and among the liquid discharge heads.

### Configuration of Liquid Discharge Apparatus

A configuration of a liquid discharge apparatus according to an embodiment of the present disclosure will be described below with reference to the drawings. The configuration described below can adopt the configuration according to the above-described embodiments. The X, Y, and Z directions illustrated in the following drawings in the present and subsequent embodiments are different from the previous definition of coordinates in the above-described embodiments.

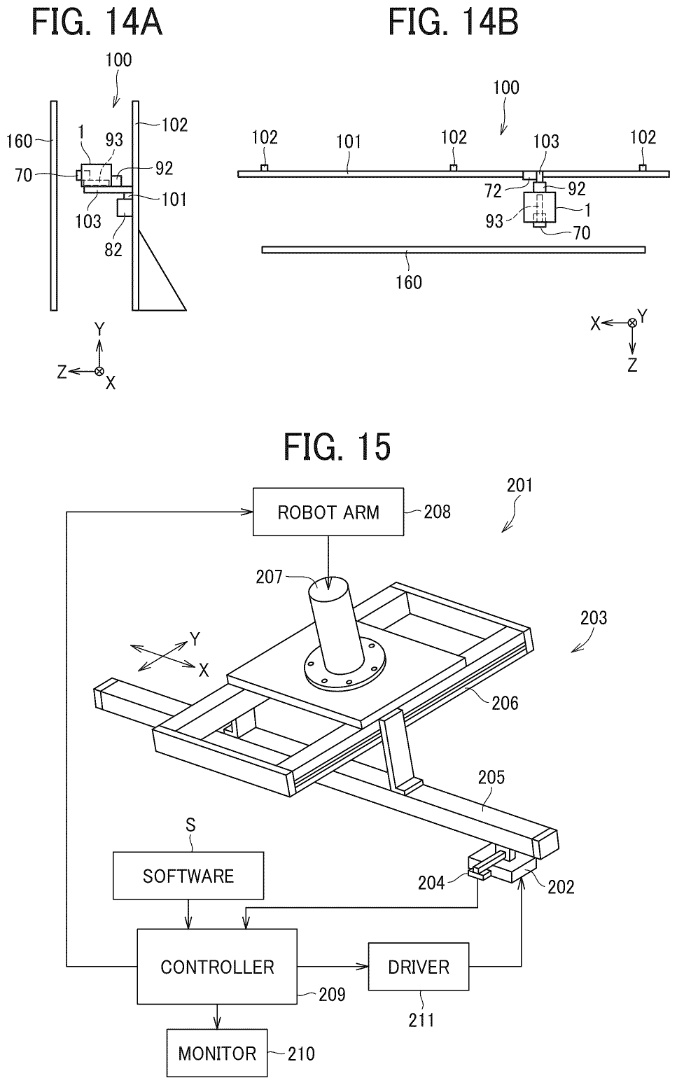

FIGS. 14A and 14B are diagrams each illustrating an overall schematic configuration of a liquid discharge apparatus 100, according to an embodiment of the present disclosure. FIG. 14A is a side view of the liquid discharge apparatus 100, and FIG. 14B is a plan view of the liquid discharge apparatus 100. The liquid discharge apparatus 100 is installed facing an object 160 to which liquid is applied. The liquid discharge apparatus 100 includes an X-axis rail 101, a Y-axis rail 102, and a Z-axis rail 103. The Y-axis rail 102 intersects the X-axis rail 101, and the Z-axis rail 103 intersects the X-axis rail 101 and the Y-axis rail 102. In particular, in the present embodiment, the X-axis, Y-axis, and Z-axis rails 101,102, and 103 extend in directions orthogonal to each other.

The Y-axis rail 102 holds the X-axis rail 101 so that the X-axis rail 101 is movable in a Y-direction. The X-axis rail 101 holds the Z-axis rail 103 so that the Z-axis rail 103 is movable in an X-direction. The Z-axis rail 103 holds a carriage 1, which serves as a discharge head support, such that the carriage 1 can move in the Z-direction.

The liquid discharge apparatus 100 includes a first Z-direction driver 92 and an X-direction driver 72. The first Z-direction driver 92 moves the carriage 1 in the Z-direction along the Z-axis rail 103. The X-direction driver 72 moves the Z-axis rail 103 in the X-direction along the X-axis rail 101. The liquid discharge apparatus 100 further includes a Y-direction driver 82 that moves the X-axis rail 101 in the Y-direction along the Y-axis rail 102. Further, the liquid discharge apparatus 100 includes a second Z-direction driver 93 that moves a head holder 70 relative to the carriage 1 in the Z-direction.

The liquid discharge head 10 described above is attached to the head holder 70 mounted on the carriage 1 so that the nozzle 14 (see FIG. 2) of the liquid discharge head 10 faces the object 160. The liquid discharge apparatus 100 described above discharges ink as a liquid from the liquid discharge head 10 attached to the head holder 70 toward the object 160 while the carriage 1 moves along the X-axis, the Y-axis, and the Z-axis to move the liquid discharge head 10. As a result, images are printed on the object 160.

Subsequently, an inkjet printer 201, which is another liquid discharge apparatus, is described below with reference to FIGS. 15, 16, and 17. As illustrated in FIG. 15, the inkjet printer 201 according to the present embodiment includes the print head 202, an X-Y table 203, a camera 204, a controller 209, and a driver 211.

The print head 202 is an inkjet liquid discharge head, such as the liquid discharge head 10 described above, that discharges ink (liquid) toward the surface of an object M to be coated. The term “ink” in the present disclosure includes “paint.” The print head 202 includes a plurality of valve-type nozzles and discharges ink from each valve-type nozzle in a direction perpendicular to a discharge surface of the print head 202. The discharge surface of the print head 202 from which ink is discharged is parallel to the X-Y plane formed by the movement of the X-Y table 203, and the ink is discharged from each valve-type nozzle in the direction perpendicular to the X-Y plane. The ink is discharged from the respective valve-type nozzles in parallel to each other. Each valve-type nozzle communicates with an ink tank of a predetermined color. The ink tank is pressurized by a pressurizing device. A distance between each valve-type nozzle and the surface of the object M to be coated is preferably about 20 cm to discharge ink from each valve-type nozzle onto the surface of the object M as desired.

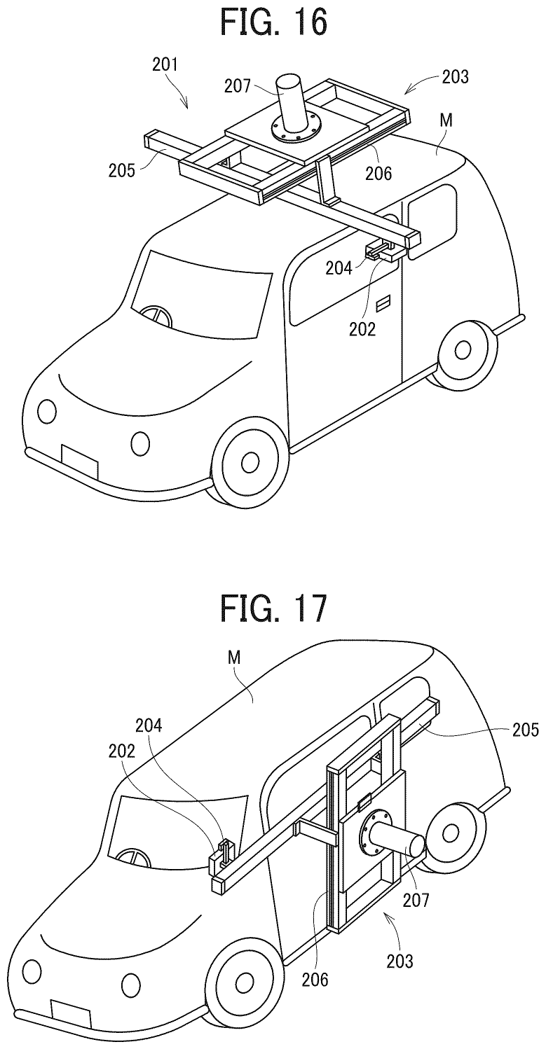

The X-Y table 203 includes a mechanism that moves the print head 202 and the camera 204 in the X and Y directions orthogonal to each other. Specifically, the X-Y table 203 includes an X-axis moving mechanism 205 that moves a slider holding the print head 202 and the camera 204 to be described later in the X direction, and a Y-axis moving mechanism 206 that moves the X-axis moving mechanism 205 in the Y direction while holding the X-axis moving mechanism 205 by two arms. The Y-axis moving mechanism 206 includes a shaft 207, and a robot arm 208 holds and drives the shaft 207 to freely move the print head 202 to a predetermined position at which the print head 202 coats the object M with ink. For example, when the object M is the automobile, the robot arm 208 can position the print head 202 above the automobile as illustrated in FIG. 16 or lateral to the automobile as illustrated in FIG. 17. An operation of the robot arm 208 is controlled based on a program stored in advance in the controller 209.

The camera 204 is an imaging device such as a digital camera that captures an image of the surface of the object M to be coated. The camera 204 is moved in the X direction and the Y direction by the X-axis moving mechanism 205 and the Y-axis moving mechanism 206, and captures an image of the surface of the object M in a predetermined area at small constant intervals. Specifications such as characteristics of a lens and the resolution of the camera 204 are appropriately determined to enable the camera 204 to capture multiple subdivided images of a predetermined area of the surface of the object M. The controller 209 described below causes the camera 204 to continuously and automatically capture the multiple subdivided images of the surface of the object M.

The controller 209 operates the X-Y table 203 based on image editing software S for editing an image captured by the camera 204 and a preset control program to control a printing operation (ink discharge operation) of the print head 202. Examples of the controller 209 include a so-called microcomputer, and the controller 209 includes a storage device that records and stores various programs, data of captured images, and data of images to be printed, a central processing unit that executes various processing according to the programs, an input device such as a keyboard and a mouse, and a digital versatile disk (DVD) player if desired. The controller 209 further includes a monitor 210. The monitor 210 displays, for example, input information to the controller 209, a processing result by the controller 209.

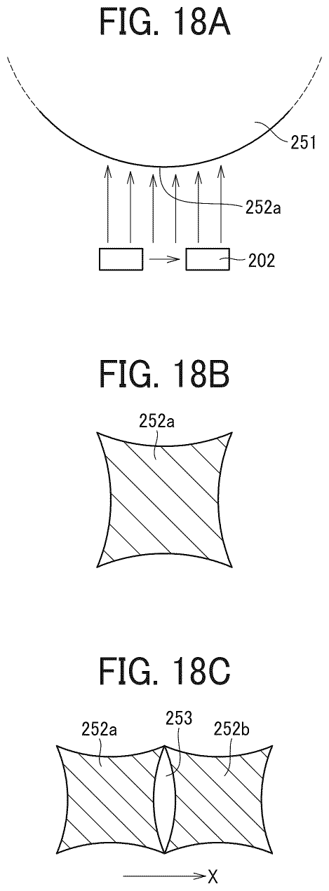

When an image is printed on the surface of the object M that is not flat, the controller 209 performs image processing on data of the multiple subdivided images captured by the camera 204 using image processing software, and generates a composite print surface onto which the surface of the object M is projected. The controller 209 edits an image to be printed on the surface of the object M so that the image to be printed is continuously connected to a printed image that has already been printed on the surface of the object M at the edges of the image to be printed and the printed image on the composite print surface to create an edited image to be printed. For example, for a printed image 252b that is the image to be printed as illustrated in FIG. 18C, the printed image 252b is edited in a manner of being matched with the composite print surface such that a non-print region 253 is not formed between the printed image 252b and an adjacent printed image 252a. As a result, the edited image to be printed is created. The print head 202 discharges ink onto the surface of the object M based on the created edited image to be printed. As a result, the image 252b is printed adjacent to the printed image 252a without a gap between the image 252b and the printed image 252a. The controller 209 controls the driver 211 to cause the camera 204 to capture the multiple subdivided images and to cause the print head 202 to discharge ink from each nozzle to print an image on the object M.

The print head 202 discharges ink from each nozzle 14 to form a two-dimensional quadrangular image on the spherical surface 251 of the object M by inkjet method in the direction illustrated in FIG. 18A. Since the print head 202 discharges the ink from each nozzle 14 in the direction perpendicular to the print head 202, the printed image 252a printed on the spherical surface 251 of the object M may have a quadrangular shape with a deformed (bent) periphery as illustrated in FIG. 18B without image processing described above.

### Electrode Manufacturing Apparatus

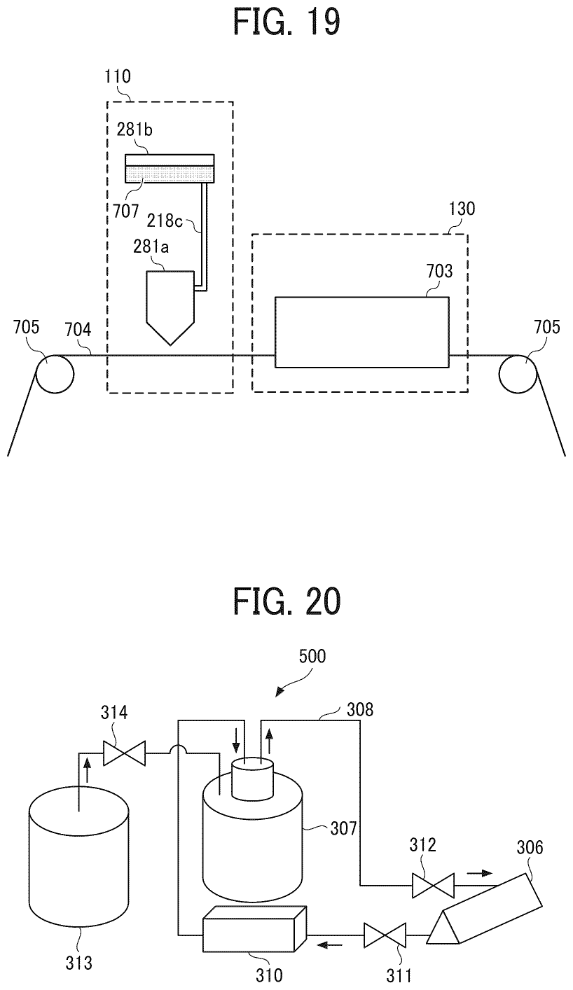

Embodiments according to the present disclosure include apparatuses for manufacturing electrodes and electrochemical devices. An electrode manufacturing apparatus is described below. FIG. 19 is a schematic view of an electrode manufacturing apparatus according to an embodiment of the present disclosure. The electrode manufacturing apparatus uses the above-described liquid discharge apparatus to discharge a liquid composition in order to manufacture an electrode having a layer containing an electrode material.

### Device to Form Layer Containing Electrode Material and Process of Forming Layer

### Containing Electrode Material

A discharge device in the present embodiment is the above-described liquid discharge apparatus. The liquid discharge apparatus discharges and applies the liquid composition onto an object to form a liquid composition layer. The object is not limited to any particular object and can be suitably selected to suit to any application. The object is any object on which a layer containing an electrode material can be formed, such as an electrode substrate (current collector), an active material layer, and a layer containing a solid electrode material. The object may be referred to as an object onto which liquid is discharged or a discharge object in the following description. If the discharge device can form the layer containing the electrode material on the object on which liquid is discharged in a discharge process, the discharge device may directly discharge the liquid composition or may indirectly discharge the liquid composition to form the layer containing the electrode material.

### Other Devices and Other Processes

Other devices in the electrode manufacturing apparatus, which forms an electrode composite layer, are not limited to any particular device and can be suitably selected to suit to any application as long as the effects of the present embodiment are not impaired. Examples of the device include a heating device. Other processes performed by the electrode manufacturing apparatus, which forms an electrode composite layer, are not limited to any particular process and can be suitably selected to suit to any application as long as the effects of the present embodiment are not impaired. Examples of the process include a heating process.

### Heating Device and Heating Process

The heating device heats the liquid composition discharged by the discharge device. In the heating process, the liquid composition discharged in the discharge process is heated. The liquid composition layer can be dried by heating.

Configuration in which Layer Containing Electrode Material is Formed by Directly Discharging Liquid Composition

An electrode manufacturing apparatus according to an embodiment of the present disclosure, which forms an electrode composite layer containing an active material on an electrode substrate (current collector), is described below. The electrode manufacturing apparatus includes a discharge process unit 110 and a heating process unit 130. The discharge process unit 110 performs the discharge process in which the liquid composition is applied to a print base material 704 having the discharge object to form the liquid composition layer. The heating process unit 130 performs a heating process in which the liquid composition layer is heated to obtain the electrode composite layer.

The electrode manufacturing apparatus further includes a conveyance unit 705 that conveys the print base material 704. The conveyance unit 705 conveys the print base material 704, at a preset speed, to the discharge process unit 110 and the heating process unit 130 in this order. A method of producing the print base material 704 having the discharge object such as the active material layer is not limited to any particular method, and a known method can be appropriately selected. The discharge process unit 110 includes a printer 281a including the liquid discharge head 10 according to the above-described embodiments, a storage container 281b, and a supply tube 281c. The printer 281a performs an application process of applying a liquid composition 707 onto the print base material 704. The storage container 281b stores the liquid composition 707. The supply tube 281c supplies the liquid composition 707 stored in the storage container 281b to the printer 281a.

The storage container 281b stores the liquid composition 707, and the discharge process unit 110 discharges the liquid composition 707 from the printer 281a to apply the liquid composition 707 onto the print base material 704 to form the liquid composition layer in a thin film shape. The storage container 281b may be integrated with the electrode manufacturing apparatus that forms the electrode composite layer or may be detachable from the electrode manufacturing apparatus. The storage container 281b includes a container for adding the liquid composition 707 to the storage container integrated with the electrode manufacturing apparatus or the storage container detachable from the electrode manufacturing apparatus. The storage container 281b that stably stores the liquid composition 707 and the supply tube 281c that stably supplies the liquid composition 707 can be used.

As illustrated in FIG. 19, the heating process unit 130 includes a heater 703 to perform a solvent removing process in which the solvent remaining in the liquid composition layer is heated and dried by the heater 703 to be removed. Thus, the electrode composite layer can be formed. The heating process unit 130 may perform the solvent removing process under reduced pressure. The heater 703 is not limited to any particular device and can be suitably selected to suit to any application. Examples of the heater 703 include a substrate heating device, an infrared (IR) heater, a hot-air heater, and the combination thereof. The heating temperature and time can be appropriately selected according to the boiling point of the solvent contained in the liquid composition 707 and the thickness of the formed film. FIG. 20 is a schematic view of another electrode manufacturing apparatus (liquid discharge apparatus) according to an embodiment of the present disclosure. A liquid discharge apparatus 500 can circulate the liquid composition through a discharge head 306 including the liquid discharge head 10 described above, a tank 307, and a tube 308 by controlling a pump 310 and control valves 311 and 312. The liquid discharge apparatus 500 includes an external tank 313. When the liquid composition in the tank 07 is reduced, the pump 310 and the control valves 311 and 312, and a control valve 314 are controlled such that the liquid composition can be supplied from the external tank 313 to the tank 307. When the electrode manufacturing apparatus according to the present embodiment is used, the liquid composition can be discharged to a target portion of the discharge object. The electrode composite layer can be suitably used, for example, as a part of the configuration of an electrochemical element. The configuration of the electrochemical element other than the electrode composite layer is not limited to any particular configuration and may be appropriately selected from known configurations. Examples thereof include a positive electrode, a negative electrode, and a separator.

The above-described embodiments of the present disclosure are examples, and the following aspects of the present disclosure can provide, for example, advantageous effects described below.

### First Aspect

According to a first aspect (Aspect 1), an actuator unit includes: a piezoelectric element (for example, the piezoelectric element 18); a valve body (for example, the needle valve 17) that is movable in an expansion-contraction direction of the piezoelectric element; a piezoelectric element support (for example, the piezoelectric element support 65) that supports one end (for example, the piezoelectric element support point 65a) of the piezoelectric element in the expansion-contraction direction; and a movement mechanism (for example, the movement mechanism 58) that is coupled to the valve body and another end (for example, the guide 58c) of the piezoelectric element in the expansion-contraction direction and moves the valve body in accordance with expansion of the piezoelectric element. The movement mechanism includes a fixing portion (for example, the fixing portion 58b) that fixes a position of the fixing portion with respect to the piezoelectric element support, and the actuator unit includes a restrictor (for example, the restrictor 63) that regulates a position of the fixing portion with respect to the piezoelectric element support.

In other words, an actuator includes a piezoelectric element, a valve body, a support (e.g., the piezoelectric element support 65), a movement mechanism, and a restrictor. The piezoelectric element expands and contracts in an expansion-contraction direction. The valve body is movable in the expansion-contraction direction. The support is fitted around the piezoelectric element to expand and contract in the expansion-contraction direction with an expansion and a contraction of the piezoelectric element. The movement mechanism is coupled to the valve body and coupled to the piezoelectric element via the support. The movement mechanism moves the valve body in accordance with the expansion and the contraction of the piezoelectric element. The movement mechanism includes a fixing portion fixing a relative position of the movement mechanism to the support. The restrictor is fixed to each of the support and the fixing portion to regulate a relative position of the fixing portion to the support.

### Second Aspect

According to a second aspect (Aspect 2), in the first aspect, the movement mechanism includes: a mover (for example, the bent portion 58d) that is coupled to the piezoelectric element and moves toward the valve body with respect to the fixing portion in accordance with expansion of the piezoelectric element; and a valve mover (for example, the deformable portion 58a) that moves the valve body toward the piezoelectric element with respect to the fixing portion in accordance with movement of the mover.

In other words, the movement mechanism includes a bent portion movable toward the valve body relative to the fixing portion in accordance with the expansion of the piezoelectric element and a deformable portion to move the valve body toward the piezoelectric element relative to the fixing portion in accordance with a movement of the bent portion toward the valve body.

### Third Aspect

According to a third aspect (Aspect 3), in the first aspect or the second aspect, a longitudinal direction of the restrictor is parallel to a longitudinal direction of the piezoelectric element.

In other words, the restrictor extends in a direction parallel to a longitudinal direction of the piezoelectric element.

### Fourth Aspect

According to a fourth aspect (Aspect 4), in any one of the first to third aspects, the restrictor is formed of a single component.

### Fifth Aspect

According to a fifth aspect (Aspect 5), in the second aspect, the actuator unit further includes a fixing member (for example, the first fixing member 62) that fixes the restrictor and the fixing portion, and a coupling point (for example, the fulcrum of the movement mechanism 58) between the fixing portion and the mover does not rotate about a central axis of the fixing member.

In other words, the actuator according to the second aspect, further includes a fixing member fixing the fixing portion to the restrictor. The fixing member restricts a rotation of a coupling point between the fixing portion and the bent portion about a central axis of the fixing member.

### Sixth Aspect

According to a sixth aspect (Aspect 6), in the fifth aspect, the movement mechanism and the fixing member are integrated.

In other words, the movement mechanism and the fixing member are fixed to each other to form a single body.

### Seventh Aspect

According to a seventh aspect (Aspect 7), in any one of the first to sixth aspects, the restrictor is formed of a metal having a coefficient of thermal expansion smaller than, at least, a coefficient of thermal expansion of the support (piezoelectric element support).

### Eighth Aspect

According to an eighth aspect (Aspect 8), in any one of the first to seventh aspects, when a predetermined voltage is applied to the piezoelectric element, a movement distance of the valve body is longer than a length by which the piezoelectric element expands.

In other words, the valve body is movable by a distance longer than a length of the expansion of the piezoelectric element to which a predetermined voltage is applied.

### Ninth Aspect

According to a ninth aspect (Aspect 9), in any one of the first to eighth aspects, the actuator unit includes at least two restrictors, and the fixing portion is fixed by being sandwiched between the at least two restrictors.

In other words, the actuator according to any one of the first to eighth aspects, further includes at least two restrictors including the restrictor. The fixing portion is sandwiched and fixed between the at least two restrictors.

### Tenth Aspect

According to a tenth aspect (Aspect 10), in the second aspect, the actuator unit further includes an elastic member (for example, the spring portion 67) that is coupled to the mover on one side and coupled to the piezoelectric element support on another side to bias the mover toward the piezoelectric element.

In other words, the support includes an elastic portion deformable in accordance with the expansion of the piezoelectric element to bias the bent portion toward the piezoelectric element.

### Eleventh Aspect

According to an eleventh aspect (Aspect 11), in the tenth aspect, the piezoelectric element support, the elastic member, and the movement mechanism are included in a single unit.

In other words, the support, the elastic portion, and the movement mechanism form a single unit.

### Twelfth Aspect

According to a twelfth aspect (Aspect 12), in any one of the first to eleventh aspects, the restrictor has an opening (for example, the piezoelectric element opening 63c) in a region corresponding to a side of the piezoelectric element.

In other words, the restrictor has an opening in which the piezoelectric element is arranged.

### Thirteenth Aspect

According to a thirteenth aspect (Aspect 13), a liquid discharge head (for example, the liquid discharge head 10) includes the actuator unit according to any one of the first to twelfth aspects and a housing (for example, the housing 11) including: a nozzle hole (for example, the nozzle 14) that discharges a liquid (for example, the ink 150); a liquid chamber (for example, the channel 16) that communicates with the nozzle hole; and an accommodating unit (for example, the space 11a) that accommodates the actuator unit. The valve body opens the nozzle hole in accordance with expansion of the piezoelectric element.

In other words, a liquid discharge head includes the actuator according to any one of the first to twelfth aspects and a housing. The housing has a nozzle hole from which a liquid is dischargeable, a liquid chamber communicating with the nozzle hole, and an accommodation space accommodating the actuator. The valve body opens the nozzle hole in accordance with the expansion of the piezoelectric element.

### Fourteenth Aspect

According to a fourteenth aspect (Aspect 14), a liquid discharge apparatus (for example, the liquid discharge apparatus 100) includes the liquid discharge head according to the thirteenth aspect.

In other words, a liquid discharge apparatus includes the liquid discharge head according to the thirteenth aspect and a carriage mounting the liquid discharge head to move the liquid discharge head.

As described above, according to one aspect of the present disclosure, the variations in the movement amount of the valve body can be reduced.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. An actuator comprising:
a piezoelectric element to expand and contract in an expansion-contraction direction;
a valve body movable in the expansion-contraction direction;
a support fitted around the piezoelectric element to expand and contract in the expansion-contraction direction with an expansion and a contraction of the piezoelectric element;
a movement mechanism coupled to:
the valve body; and
the piezoelectric element via the support,
to move the valve body in accordance with the expansion and the contraction of the piezoelectric element, and
the movement mechanism including a fixing portion fixing a relative position of the movement mechanism to the support; and
a restrictor fixed to each of the support and the fixing portion to regulate a relative position of the fixing portion to the support.

2. The actuator according to claim 1,
wherein the movement mechanism includes:
a bent portion movable toward the valve body relative to the fixing portion in accordance with the expansion of the piezoelectric element; and
a deformable portion to move the valve body toward the piezoelectric element relative to the fixing portion in accordance with a movement of the bent portion toward the valve body.

3. The actuator according to claim 1,
wherein the restrictor extends in a direction parallel to a longitudinal direction of the piezoelectric element.

4. The actuator according to claim 1,
wherein the restrictor is formed of a single component.

5. The actuator according to claim 2, further comprising a fixing member fixing the fixing portion to the restrictor,
wherein the fixing member restricts a rotation of a coupling point between the fixing portion and the bent portion about a central axis of the fixing member.

6. The actuator according to claim 5,
wherein the movement mechanism and the fixing member are fixed to each other to form a single body.

7. The actuator according to claim 1,
wherein the restrictor is formed of a metal having a coefficient of thermal expansion smaller than a coefficient of thermal expansion of the support.

8. The actuator according to claim 1,
wherein the valve body is movable by a distance longer than a length of the expansion of the piezoelectric element to which a predetermined voltage is applied.

9. The actuator according to claim 1, further comprising at least two restrictors including the restrictor,
wherein the fixing portion is sandwiched and fixed between the at least two restrictors.

10. The actuator according to claim 2,
wherein the support includes an elastic portion deformable in accordance with the expansion of the piezoelectric element to bias the bent portion toward the piezoelectric element.

11. The actuator according to claim 10,
wherein the support, the elastic portion, and the movement mechanism form a single unit.

12. The actuator according to claim 1,
wherein the restrictor has an opening in which the piezoelectric element is arranged.

13. A liquid discharge head comprising:
the actuator according to claim 1; and
a housing having:
a nozzle hole from which a liquid is dischargeable;
a liquid chamber communicating with the nozzle hole; and
an accommodation space accommodating the actuator,
wherein the valve body opens the nozzle hole in accordance with the expansion of the piezoelectric element.

14. A liquid discharge apparatus comprising:
the liquid discharge head according to claim 13; and
a carriage mounting the liquid discharge head to move the liquid discharge head.
